(19) United States
(12) Patent Application Publication
(10) Pub. No.: US 2017/0243668 A1
(43) Pub. Date: Aug. 24, 2017

(54) CARBON NANOTUBE-COATED SUBSTRATES AND METHODS OF MAKING THE SAME

(71) Applicant: William Marsh Rice University, Houston, TX (US)

(72) Inventors: Matteo Pasquali, Houston, TX (US); Francesca Mirri, Houston, TX (US); Tienyi Theresa Hsu Whiting, Doylestown, OH (US)

(73) Assignee: William Marsh Rice University, Houston, TX (US)

(21) Appl. No.: 15/113,624

(22) PCT Filed: Jan. 26, 2015
(86) PCT No.: PCT/US15/12938

§ 371 Date: Jul. 22, 2016

Related U.S. Application Data
(60) Provisional application No. 61/931,097, filed on Jan. 24, 2014.

(51) Int. Cl. H01B 1/04; B05D 1/28; B05D 3/10; B05D 1/42; B05D 3/02; B05D 3/04; B05D 1/18; B05D 1/26

(52) U.S. Cl. CPC H01B 1/04; B05D 1/18; B05D 1/28; B05D 1/265; B05D 1/42; B05D 3/0272; B05D 3/0406; B05D 3/107; C01B 31/0273; B82Y 40/00

(57) ABSTRACT

Various embodiments of the present disclosure pertain to methods of making carbon nanotube-coated substrates by dissolving carbon nanotubes in a solvent to form a carbon nanotube solution; and coating a surface of a substrate with the carbon nanotube solution to form one or more carbon nanotube layers on the surface of the substrate. The carbon nanotube solution may include a superacid solvent. A cable made out of the carbon nanotube-coated substrates may include one or more internal insulating layers that surround the surface of one or more internal conductors. Carbon nanotube solutions may be coated onto the one or more internal insulating layers to form one or more carbon nanotube layers. Additional embodiments of the present disclosure pertain to carbon nanotube-coated substrates formed by the methods of the present disclosure. The carbon nanotube-coated substrates may include one or more carbon nanotube layers derived from a carbon nanotube solution.

### CROSS-REFERENCE TO RELATED APPLICATIONS

This application claims priority to U.S. Provisional Patent Application No. 61/931,097, filed on Jan. 24, 2014. The entirety of the aforementioned application is incorporated herein by reference.

### STATEMENT REGARDING FEDERALLY SPONSORED RESEARCH

This invention was made with government support under Grant No. FA 9550-12-1-0035, awarded by the U.S. Department of Defense; and Grant No. FA 9550-09-1-0590, awarded by the U.S. Department of Defense. The government has certain rights in the invention.

### BACKGROUND

Commercial electrical cables have performance limitations, especially at high frequency and in situations where mechanical flexing is required. As such, a need exists for improved methods of forming the aforementioned materials with improved electrical performance.

### SUMMARY

In some embodiments, the present disclosure pertains to methods of making carbon nanotube-coated substrates. In some embodiments, the methods include dissolving carbon nanotubes in a solvent to form a carbon nanotube solution, and coating the surface of the substrate with the carbon nanotube solution. In some embodiments, the coating forms one or more carbon nanotube layers on the surface of the substrate.

In some embodiments, the carbon nanotube solution has a carbon nanotube concentration ranging from about 0.01% by weight to about 20% by weight. In some embodiments, the carbon nanotube solution includes a strong acid or a superacid. In some embodiments, the carbon nanotube solution is in a liquid crystalline state or an isotropic phase. In some embodiments, the carbon nanotube solution is in a liquid crystalline state and an isotropic phase.

In some embodiments, the carbon nanotube solution is coated onto a surface of a substrate by dip coating. In some embodiments, the substrate is a cable dielectric (i.e., an internal insulating layer of a cable). In some embodiments, the carbon nanotube-coated substrate is a component of a cable. In some embodiments, the cable includes one or more internal conductors. In some embodiments, the one or more internal conductors include carbon nanotube fibers. In some embodiments, the cable also includes one or more internal insulating layers that surround a surface of the one or more internal conductors. In some embodiments, the carbon nanotube solution is coated onto a surface of the one or more internal insulating layers to form one or more carbon nanotube layers on a surface of the one or more internal insulating layers. In some embodiments, the one or more carbon nanotube-coated substrate is then associated with one or more external insulating layers to form a cable.

In some embodiments, the substrate is in the form of a sheet with a front surface and a back surface. In some embodiments, the carbon nanotube solution is coated onto at least one of the front surface and the back surface of the substrate to form one or more carbon nanotube layers on at least one of the front surface and the back surface of the substrate. In some embodiments, the carbon nanotube solution is coated onto the front surface and the back surface of the substrate to form one or more carbon nanotube layers on each of the front surface and the back surface of the substrate (also referred to as a double-side shielded layer).

In some embodiments, the one or more carbon nanotube layers include unidirectionally aligned carbon nanotubes that are aligned along an axis of the substrate (e.g., alignment along a draw direction). In some embodiments, the unidirectionally aligned carbon nanotubes are in the form of bundles. In some embodiments, the one or more carbon nanotube layers include neat carbon nanotubes.

In some embodiments, the methods of the present disclosure also include a step of removing the solvent from the carbon nanotubes. In some embodiments, the removing occurs by coagulation, such as by exposure of the carbon nanotubes to a coagulant.

In some embodiments, the methods of the present disclosure also include a step of washing the carbon nanotubes. In some embodiments, the methods of the present disclosure also include a step of drying the carbon nanotubes. In some embodiments, the methods of the present disclosure also include a step of associating the substrate with one or more external insulating layers.

Additional embodiments of the present disclosure pertain to carbon nanotube-coated substrates that are formed by the methods of the present disclosure. In some embodiments, the carbon nanotube-coated substrates of the present disclosure include one or more carbon nanotube layers that are derived from a carbon nanotube solution.

In some embodiments, the carbon nanotube-coated substrates of the present disclosure are components of a cable. In some embodiments, the substrate is a cable dielectric (i.e., an internal insulating layer of a cable). In some embodiments, the cable includes one or more internal conductors and one or more internal insulating layers that surround a surface of the one or more internal conductors. In some embodiments, the one or more carbon nanotube layers are on a surface of the one or more internal insulating layers. In some embodiments, the one or more carbon nanotube layers serve as an outer conductor layer or an electromagentic shielding layer of a cable. In some embodiments, the carbon nanotube-coated substrates of the present disclosure are also associated with one or more external insulating layers.

### DESCRIPTION OF THE FIGURES

FIG. 1 is a scheme of a method of making carbon nanotube-coated substrates (e.g., carbon nanotube coatings for the shielding component of cables and flat substrates).

FIG. 2 provides depictions of cable 20, where carbon nanotube layer 26 serves as an outer conductor or an electromagnetic shielding component. The depictions are shown in FIGS. 2A-B.

FIG. 3 provides schematics of various dip coating processes for making carbon nanotube coatings for various substrates (e.g., cables and tapes). FIG. 3A illustrates the immersion of a substrate (e.g., a wire with an external insulating layer (cable dielectric) or flat substrate) into a carbon nanotube (CNT) solution and lifting at controlled speed rate to allow a thin layer of carbon nanotubes to adhere on the surface of the substrate. FIG. 3B illustrates a continuous dip coating process where the substrate is pulled into the CNT solution by a rotating roller. The substrate is then extracted from the CNT solution, where it can be directed to a coagulation and washing bath and/or an oven/air drying chamber.

FIG. 4 provides a scheme of a wire coating method for forming carbon nanotube coatings for various substrates (e.g., cables and tapes). In this scheme, the substrate (e.g., a wire with an external insulating layer (cable dielectric) or flat substrate) is guided into a cross-head die by a wire guider. The substrate is kept in tension by rolls. The CNT solution fills the cross-head chamber and surrounds the substrate. The coated substrate exits the cross-head, where it can be redirected to a coagulation and washing bath and/or an oven/air drying chamber.

FIG. 5 provides schemes of slot coating (FIG. 5A) and extrusion coating (FIG. 5B) methods for forming carbon nanotube coatings (e.g., in the form of a tape) onto a substrate (e.g., an insulating substrate). In these schemes, the substrate (e.g., in the form of a flat layer) is moved between liquid distribution chambers that contain CNT solutions. Thereafter, the CNT solution is deposited on both sides of the moving substrate.

FIG. 6 provides a scheme of a slide coating method for forming carbon nanotube coatings (e.g., in the form of a tape) onto a substrate (e.g., an insulating substrate). In this scheme, a substrate (e.g., in the form of a flat layer) is moved in close proximity to containers containing CNT solutions. This results in the coating on both sides of the substrate. Coagulation and washing baths can be placed between the two rotating rolls or after the second roll.

FIG. 7 provides a scheme of a knife coating method for forming carbon nanotube coatings (e.g., in the form of a tape) onto an insulating substrate. In this scheme, a substrate (e.g., in the form of a flat layer) is moved in close proximity to the knives that meter the CNT solution.

FIG. 8 provides a scheme of a roll coating method for forming carbon nanotube coatings (e.g., in the form of a tape) onto an insulating substrate. In this scheme, a substrate (e.g., in the form of a flat layer) is moved between two rotating rolls that allow the solution to deposit on the moving web.

FIG. 9 provides various images and schemes relating to the fabrication of CNT coaxial cables. FIG. 9A is a photograph of a CNT coaxial cable with SubMiniature version A (SMA) connectors (Inset: SMA connector at an auxillary view). FIG. 9B provides schematics of a CNT coaxial cable compared to a conventional commercial cable (top) and photographs of the CNT coaxial cables and the convential commercial cable with the different coatings (bottom). FIG. 9C provides laboratory-based dip-coating process used to coat the coaxial cables for the data presented in FIGS. 18-19. FIG. 9D provides a scalable dip-coating process for CNT coating.

FIG. 10 shows various images of CNT coaxial cables. FIG. 10A shows that a Teflon tape is wrapped around the ends of the dielectric and then coated by the CNT layer. FIG. 10B shows that a Teflon tape is removed exposing the PE dielectric. The PVC jacket is placed on the top of CNT layer. FIG. 10C shows that a 1/16 inch piece of dielectric is removed to expose the copper wire. FIG. 10D shows that the inner pin of the SMA female connector is placed on the copper wire and soldered. FIG. 10E shows that the outer connector is inserted on the top of the inner pin and the CNT layer is wrapped around it. FIG. 10F shows that a silver epoxy is placed on the top of the CNT layer to secure the CNT-connector contact. FIG. 10G shows that a metal connector ring is crimped on the top of the silver epoxy. Once the silver epoxy is dried, the connector is insulated with electric tape.

FIG. 11 shows data relating to the thickness of the CNT outer conductor after 1, 3, and 7 coatings achieved with a CNT-CSA solution containing a mass fraction of 1.3% CNT and a withdrawal speed of 100 mm/s. The thickness was estimated using a microcaliper (FIG. 11A) and SEM imaging (FIG. 11B).

FIG. 12 shows data illustrating that coating thickness can be tuned by varying the solution concentration and coating speed. Viscosity versus shear rate for CNT-CSA solutions with mass fractions of 1 and 1.3% are shown, where n represents the power law exponent (FIG. 12A). Each data set represents an average of 3 samples independently prepared. Coating thickness versus withdrawal speed for 1 and 1.3 wt % solutions is also shown (FIG. 12B). The thickness measurements were obtained by SEM. The (2n/(2n+1)) exponent calculated using n from the rheology data and the one predicted by lubrication analysis agree within 15% for 1% solution and 3% for 1.3% solution.

FIG. 13 provides results illustrating that a dip-coating process produced carbon nanotube (CNT) outer conductors consisting of aligned bundles of CNTs parallel to the draw direction. FIG. 13A is a scanning electron microscope micrographs of the CNT layer for each thickness value. The draw direction (arrow) shows that the CNT bundles oriented along the draw direction. FIG. 13B is an atomic force microscope images of a (90±14) μm CNT coating on a coated coaxial cable show bundle alignment and uniform coverage. Far left shows an optical image of the investigated surface. FIG. 13C is a normalized scattering intensity obtained by small-angle neutron scattering measurements on the CNT coating that indicates aligned CNT bundles due to the strong anisotropy in the signal.

FIG. 14 provides various data relating to CNT coaxial cables. FIG. 14A is an order parameter map of the mapped area (4.5 mm×0.6 mm). FIG. 14B is an order parameter distribution of the 76 spectra. The average order parameter is equal to 0.34±0.143. FIG. 14C is the Raman 2D mapping for the G peak intensity (1480-1680 cm⁻¹), where the incident and scattering polarizations were parallel to the cable axis (VV), the incident polarization was parallel to the cable axis but perpendicular to the scattering polarization (VH), and incident and scattering polarizations were both perpendicular to the cable axis (HH). Higher signal intensity can be detected in the VV plot, demonstrating the preferential alignment of the CNTs along the cable axis. All the mapped area shows Raman signal demonstrating the absence of uncoated areas on the dielectric.

FIG. 15 provides additional data relating to CNT coatings. FIG. 15A shows a fit of the 2D SANS signal (FIG. 13C) to a model of aligned fibers. FIG. 15B is an annular intensity average of the 2D scattering profile in FIG. 15A. The red line represents the best fit. FIG. 15C is a 1D SANS signal from the CNT coating (data points and error bars) along with the fractal model fit to the data (red solid line).

FIG. 16 provides additional characterization of CNT coatings. FIG. 16A provides micrographs of CNT solutions taken at 0 degrees with respect to the cross polars (indicated by the arrows). FIG. 16B provides the same micrographs taken at 45 degrees with respect to the cross polars. The birefringence found in the sample indicates the presence of liquid crystals in equilibrium with an isotropic phase.

FIG. 17 illustrates a mechanical test set up. The 14.2 cm cable is connected to the 3 point bending machine and kept in tension by springs attached on each side of the cable. The cable is connected to the multimeter to measure the DC resistance while performing the tests. The radius of bending is (27±2) mm.

FIG. 18 provides additional data relating to the characterization of the CNT cables. FIG. 18A shows a direct current (DC) resistance of the CNT cables. During the 10,000 cycle bending test, the relative DC resistance of the 90 μm CNT cable increased by about 1%, demonstrating optimal mechanical durability. FIG. 18B shows a change in transmission (insertion loss) relative to the initial value, which shows that the thickest CNT coating retained their alternated current (AC) performance, even after 10,000 bending cycles.

FIG. 19 provides additional data relating to the characterization of the CNT cables. FIG. 19A shows a specific conductivity (conductivity normalized by density) of the electromagnetic shielding layer or outer conductor layer of the cable made out of carbon nanotube as a function of the coaxial cable EM shielding mass per unit length (linear density). Error bars represent ±1 standard deviation. FIG. 19B shows the attenuation constant versus frequency for the different CNT coaxial cables and the commercial cables. The multiline algorithm (solid lines) and least-squares fit (thinner lines) were used to extract the attenuation constant. The uncertainty (shaded regions) was computed by error propagation. The purple dot represents the military standard for attenuation at 1 GHz for RG174U (1.5 dB/m or 45 dB/100 ft). FIG. 19C provides normalized mass (m/mₒ) versus normalized attenuation (α/αₒ) for the CNT coaxial cables and commercial cable. Attenuation (a) was normalized by military standard attenuation (αₒ) at 1 GHz for the RG174U cable type (1.5 dB/m, dashed line). Squares are published work on RG58U cables, compared to their military standard attenuation (red dashed line). The yellow square represents the KAuBr₄ doped coating. Values closer to the origin have improved attenuation and lower mass.

FIG. 20 provides DC resistance of the inner (FIG. 20A) and outer conductor (FIG. 20B) versus cable length.

FIG. 21 provides various data relating to the characterization of CNT powder used to make the CNT solution in chlorosulfonic acid. FIG. 21A provides a Raman spectra of the CNT powder at 514, 633, and 785 nm laser wavelengths. FIG. 21B is a Radial Breathing Mode (RBM) of the CNT powder at 514, 633, and 785 nm laser wavelengths.

FIG. 22 provides data relating to specific conductivity versus outer conductor thickness (FIG. 22A) and relative specific conductivity versus time (FIG. 22B).

FIG. 23 provides distributed resistance (FIG. 23A) and distributed inductance (FIG. 23B) versus frequency. The shaded area in (FIG. 23A) represents the error in the measurement.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Many commercial cables are shielded by weaving a mesh of metal wires around an internal insulator. For instance, many commercial cables employ braided metal wires as the outer conductor or shielding layer. Such shielding requires a mechanical weaving tool, which is complex and limited in speed. The shielding also produces a non-uniform shielding layer due to the seams between the metal wires. Conversely, these seams limit the performance of the cables and wires at high frequency. Furthermore, the seams yield heavy outer conductor layers.

Carbon nanotube (CNT) shielding layers have been applied by weaving pre-formed CNT fibers or rolling CNT tapes onto an inner insulator of a cable. Such CNT shielding layers have also been formed by applying sheets of carbon nanotubes and wrapping them around an inner insulator of a cable (also referred to as a cable dielectric). However, such CNT layers also suffer from similar drawbacks, including non-uniform coverage of the insulator surfaces that in turn limit performance. Moreover, the CNT layers do not ameliorate cable electrical behavior at high-frequency due their inadequate electrical conductivity. In addition, the CNT layers are formed based on inconvenient mechanical manufacturing methods. As such, a need exists for improved methods of forming carbon nanotube shielding layers for various substrates, including cable dielectrics.

In some embodiments, the present disclosure pertains to methods of making carbon nanotube-coated substrates (e.g., carbon nanotube-coated substrates in the form of coatings for wires, cables, and flat insulating substrates). In some embodiments, the present disclosure pertains to carbon nanotube-coated substrates that are formed by the methods of the present disclosure (e.g., carbon nanotube-coated substrates as components of cables, such as electromagnetic shielding layers and/or outer conductors of cables).

Methods of Making Carbon Nanotube-Coated Substrates

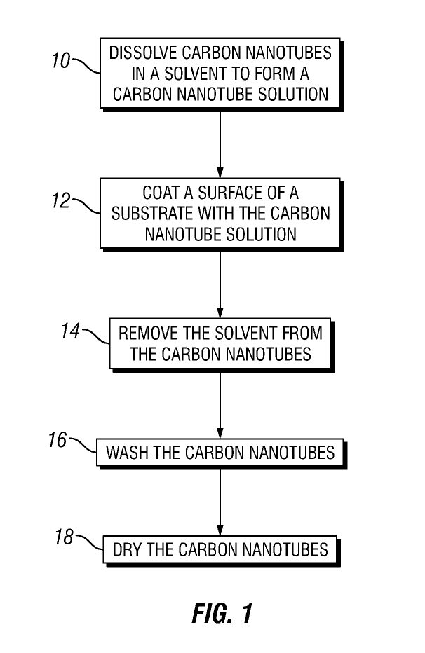

Various methods may be utilized to make carbon nanotube-coated substrates. In some embodiments illustrated in FIG. 1, the methods of the present disclosure involve dissolving carbon nanotubes in a solvent to form a carbon nanotube solution (step 10); and coating a surface of a substrate (e.g., an insulating layer of a cable (i.e., a cable dielectric) or a flat substrate) with the carbon nanotube solution (step 12) to form one or more carbon nanotube layers on the surface of the substrate (e.g., surface of an insulating layer of a cable (i.e., a dielectric layer) or surface of a flat substrate). In some embodiments, the methods of the present disclosure also include a step of removing the solvent from the carbon nanotubes (step 14) and washing the carbon nanotubes (step 16). In some embodiments, the methods of the present disclosure also include a step of drying the carbon nanotubes (step 18).

As set forth in more detail herein, various methods may be utilized to dissolve various types of carbon nanotubes in various types of solvents to form various types of carbon nanotube solutions. In addition, various methods may be utilized to coat a surface of various types of substrates with the carbon nanotube solutions to form various types of carbon nanotube layers on the surfaces of the substrates (e.g. cable dielectric surfaces or flat substrate surfaces). Moreover, various methods may be utilized to remove solvents from the carbon nanotubes, wash the carbon nanotubes, and dry the carbon nanotubes.

Dissolving Carbon Nanotubes in a Solvent

Various methods may be utilized to dissolve carbon nanotubes in a solvent. For instance, in some embodiments, carbon nanotubes are dissolved in a solvent by mixing the carbon nanotubes with the solvent. In some embodiments, the mixing can be done by stir bar mixing, centrifugal mixing, impeller mixing, and other similar methods known by one skilled in the art.

In some embodiments, the mixing occurs in a single step. In some embodiments, the mixing occurs in multiple steps. For instance, in some embodiments, aliquots of carbon nanotubes are incrementally added to a solvent. In some embodiments, aliquots of solvent are incrementally added to a carbon nanotube solution.

Additional methods of dissolving carbon nanotubes in a solvent can also be envisioned. For instance, in some embodiments, the carbon nanotubes are dissolved in a solvent by a freeze-thaw method. In such embodiments, the solvent could be frozen, granulated, and then mixed with carbon nanotubes. In some embodiment, the mixing can occur by mechanically mixing the granulated solvent with the carbon nanotubes. In some embodiments, the mixing can be facilitated by the use of one or more liquefied gases, such as liquid nitrogen, liquid carbon dioxide, liquid helium, or other liquefied gases. Thereafter, the solvent-carbon nanotube solution is heated in order to evaporate any liquified gas and melt the solvent. Any of the aforementioned mixing methods could then be used to form a carbon nanotube solution.

In some embodiments, carbon nanotubes are dissolved in a solvent in the absence of any additives. In some embodiments, carbon nanotubes are dissolved in a solvent along with one or more additives. In some embodiments, the additives can include, without limitation, polymers, coagulants, surfactants, salts, nanoparticles, dyes, dopants, and combinations thereof. In some embodiments, the additives improve the conductivity of the formed carbon nanotube layers.

Various equipment may be utilized to dissolve carbon nanotubes in a solvent. In some embodiments, the equipment can include, without limitation, single or twin-screw extruders, blenders, high shear mixers, convective mixers, mechanically agitated vessels, jet mixers, static mixers, dynamic mixers, dispersion mills, valve homogenizers, ultrasonic homogenizers, propeller mixers, turbine mixers, paddle mixers, anchor mixers, helical ribbon mixers, helical screw mixers, kneaders, extruders, and other similar apparatus.

Solvents

The carbon nanotubes of the present disclosure may be dissolved in various types of solvents. For instance, in some embodiments, the solvent includes a strong acid. In some embodiments, the solvent includes a superacid. In some embodiments, the solvent includes a strong acid and a superacid. In some embodiments, the strong acid or superacid includes, without limitation, Bronsted strong acids or superacids, Lewis strong acids or superacids, conjugate Bronsted-Lewis strong acids or superacids, and combinations thereof.

In some embodiments, the strong acid or superacid includes, without limitation, sulfuric acid, perchloric acid, chlorosulfonic acid, fluorosulfonic acid, trifluoromethane sulfonic acid, perfluoroalkane sulfonic acids, antimony pentafluoride, arsenic pentafluoride, oleums, polyphosphoric acid-oleum mixtures, tetra(hydrogen sulfate)boric acid-sulfuric acid, fluorosulfuric acid-antimony pentafluoride, fluoro sulfuric acid-SO₃, fluoro sulfuric acid-arsenic pentafluoride, fluorosulfonic acid, fluorosulfonic acid-hydrogen fluoride-antimony pentafluoride, fluorosulfonic acid-antimony pentafluoride-sulfur trioxide, fluoroantimonic acid, tetrafluoroboric acid, triflic acid, and combinations thereof.

In some embodiments, the solvent includes chlorosulfonic acid. In some embodiments, the solvent includes a mixture of chlorosulfonic acid and sulfuric acid. In some embodiments, the solvent includes superacids disclosed in Pat. App. Pub. No. WO 2009/058855. In some embodiments, the solvent includes superacids disclosed in U.S. patent application Ser. Nos. 12/740,529, 13/202,352 and 13/508,780.

Without being bound by theory or mechanism, a current understanding is that strong acids and superacids intercalate between individual carbon nanotubes in as-formed ropes or bundles of carbon nanotubes. In ropes or bundles, the individual carbon nanotubes are strongly held together by van der Waals forces. Strong acid and superacids, which have strong protonating ability, reversibly protonate the individual carbon nanotubes. The resulting electrostatic repulsion forces the carbon nanotube bundles apart, providing the carbon nanotubes as individuals. Competition between electrostatic repulsion and van der Waals attraction causes the carbon nanotubes to behave as dispersed Brownian rods in strong acid or superacid solutions. At a given concentration, rod-rod interactions begin to occur, eventually resulting in liquid crystalline behavior.

The use of additional solvents to dissolve carbon nanotubes can also be envisioned. For instance, in some embodiments, suitable acids to be used as solvents can include, without limitation, trifluoromethanesulfonic acid, fluorosulfonic acid, triflic acid, and combinations thereof.

In some embodiments, the solvent includes sulfuric acid, such as concentrated sulfuric acid. In some embodiments, the sulfuric acid has a concentration that ranges from about 80% to about 100%. In some embodiments, the sulfuric acid has a concentration that ranges from about 85% to about 96%. In some embodiments, the sulfuric acid has a concentration greater than about 80%. In some embodiments, the sulfuric acid has a concentration greater than about 90%. In some embodiments, the sulfuric acid has a concentration greater than about 95%.

In some embodiments, suitable acids to be used as solvents include a strong acid or a mixture of strong acids. Various other suitable acids to be used as solvents can be the acids disclosed in Pat. App. Pub. No. WO 2009/058855 and U.S. Pat. No. 8,591,854.

Carbon Nanotubes

Various types of carbon nanotubes may be dissolved in solvents. For instance, in some embodiments, the carbon nanotubes include, without limitation, metallic carbon nanotubes, semiconducting carbon nanotubes, single-walled carbon nanotubes, multi-walled carbon nanotubes, few-walled carbon nanotubes, double-walled carbon nanotubes, triple-walled carbon nanotubes, ultra-short carbon nanotubes, and combinations thereof. In some embodiments, the carbon nanotubes include multi-walled carbon nanotubes, such as double-walled carbon nanotubes.

The carbon nanotubes of the present disclosure can have various lengths. For instance, in some embodiments, the carbon nanotubes of the present disclosure have lengths that range from about 10 nm to about 100 μm. In some embodiments, the carbon nanotubes of the present disclosure have lengths that range from about 50 nm to about 20 μm. In some embodiments, the carbon nanotubes of the present disclosure have lengths that range from about 500 nm to about 5 μm. In some embodiments, the carbon nanotubes of the present disclosure have a length of at least about 500 nm. In some embodiments, the carbon nanotubes of the present disclosure have a length of at least about 1 μm.

The carbon nanotubes of the present disclosure can have various Raman G/D ratios. For instance, in some embodiments, the carbon nanotubes of the present disclosure have Raman G/D ratios that range from about 5 to about 200. In some embodiments, the carbon nanotubes of the present disclosure have Raman G/D ratios that range from about 10 to about 50. In some embodiments, the carbon nanotubes of the present disclosure have Raman G/D ratios of at least about 10. In some embodiments, the carbon nanotubes of the present disclosure have Raman G/D ratios of at least about 40.

Carbon Nanotube Solutions

The methods of the present disclosure can be utilized to form various types of carbon nanotube solutions. For instance, in some embodiments, the carbon nanotube solution is in a liquid crystalline state. In some embodiments, the carbon nanotube solution is in an isotropic phase. In some embodiments, the carbon nanotube solution is in a liquid crystalline state and an isotropic phase. In some embodiments, the liquid crystalline state of a carbon nanotube solution is in equilibrium with an isotropic phase of the carbon nanotube solution.

In some embodiments, the carbon nanotube solution is in a uniform state. In some embodiments, the carbon nanotube solution is in a homogenous state. In some embodiments, the carbon nanotube solution is filtered by passing the solution through multiple filters to remove undispersed particles. Such treatment can in turn improve the quality of the carbon nanotube solution.

In some embodiments, the establishment of liquid crystallinity in carbon nanotube solutions prior to coating is advantageous. For instance, in some embodiments, a high degree of liquid crystallinity prior to coating correlates well with better alignment of carbon nanotubes obtained following coating.

The carbon nanotube solutions of the present disclosure can have various concentrations of carbon nanotubes. For instance, in some embodiments, the carbon nanotube solution has a carbon nanotube concentration of more than about 1% by weight. In some embodiments, the carbon nanotube solution has a carbon nanotube concentration of more than about 10% by weight. In some embodiments, the carbon nanotube solution has a carbon nanotube concentration ranging from about 0.01% by weight to about 20% by weight. In some embodiments, carbon nanotube solutions in isotropic phase are obtained at low concentrations of carbon nanotubes in a superacid solvent (e.g., few part per million by weight of carbon nanotubes). In some embodiments, as the carbon nanotube concentration is increased (e.g., hundreds of part per million by weight of carbon nanotubes), a biphasic carbon nanotube solution with isotropic and liquid crystalline regions is produced. In some embodiments, as the carbon nanotube concentration is increased further (e.g., higher than 0.1% by weight of carbon nanotubes), the carbon nanotube solution becomes liquid crystalline.

In some embodiments, the carbon nanotube solutions of the present disclosure include carbon nanotubes with concentrations ranging from about 1% to about 1.5% by weight, and aspect ratios of about 4,000. In some embodiments, the carbon nanotubes are dissolved in chlorosulfonic acid.

Coating

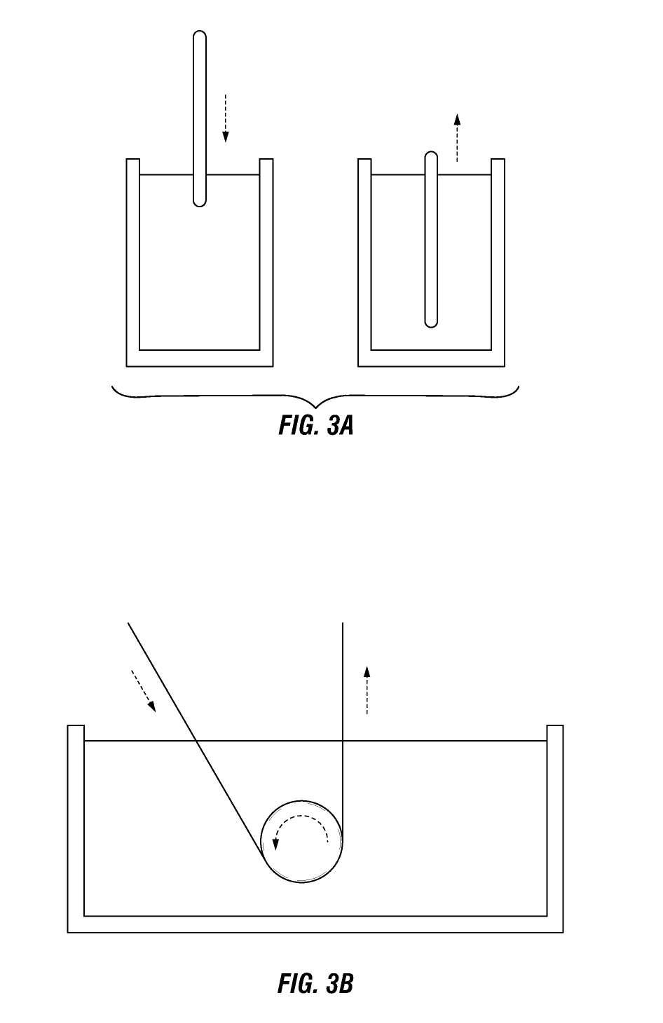

Various methods may be used to coat a surface of a substrate with a carbon nanotube solution. Exemplary coating methods are illustrated in FIGS. 3-8 and described in more detail in Example 1. For instance, in some embodiments, the coating can occur by dip coating, wire coating, die coating, slot coating, extrusion coating, slide coating, knife coating, blade coating, roll coating, and combinations thereof. In some embodiments, the coating occurs by dip coating. In some embodiments, the coating occurs a single time. In some embodiments, the coating occurs multiple times.

In some embodiments, coating processes (e.g., dip coating and die coating processes) allow for carbon nanotube alignment along an axis of a substrate (e.g., draw direction of a cable) due to the shear applied when the substrate to coat (e.g. inner conductor insulated by the dielectric of a cable) is pulled through the carbon nanotube solution. In some embodiments, a substrate is placed in and passed through a dip coating bath, a wire coating die, or another flow die. This in turn forms a liquid coating on an outer wall of the substrate (e.g. cable dielectric of a flat substrate). In some embodiments, the methods of the present disclosure can also utilize a mechanical arm or roller.

Substrates

Carbon nanotube solutions may be coated on various surfaces of various substrates. For instance, in some embodiments, the substrate is a surface of a wire. In some embodiments, the substrate is in the form of a sheet with a front surface and a back surface (e.g., a substrate in the form of a tape or a flat substrate). In some embodiments, the carbon nanotube solution is coated onto at least one of the front surface and the back surface of the substrate to form one or more carbon nanotube layers on at least one of the front surface and the back surface of the substrate. In some embodiments, the carbon nanotube solution is coated onto the front surface and the back surface of the substrate to form one or more carbon nanotube layers on each of the front surface and the back surface of the substrate. In some embodiments, the carbon nanotube-coated substrate forms an insulating substrate.

In some embodiments, the substrate is a surface of a cable component. In some embodiments, the substrate is one or more internal insulating layers (i.e., cable dielectric) of a cable. In some embodiments, the carbon nanotube solution is coated onto a surface of one or more internal insulating layers. In such embodiments, one or more carbon nanotube layers can form on a surface of the one or more internal insulating layers.

In some embodiments, the one or more internal insulating layers could have any cross-sectional shape, including circular, oval, square, hexagonal, rectangular, or irregular. In some embodiments, the one or more internal insulating layers could be a combination of individual internal insulating layers combined together into a bundle. In some embodiments, the internal insulating layers of the present disclosure are in the form of a flat substrate. In some embodiments, the internal insulating layers of the present disclosure are circular.

In some embodiments, the one or more internal insulating layers of the present disclosure can be made of solid polyethylene (PE), Teflon, polytetrafluoroethylene (PTFE), perfluoroalkoxy (PFA), ethylene tetrafluoroethylene (ETFE), cross-linked ETFE (XLETFE), low density tetrafluorethylene (LDTFE), air spaced PE, foam PE, or any other internal insulating layer materials in the state of a dense solid or a foam.

In some embodiments, the one or more internal insulating layers surround a surface of one or more internal conductors. In some embodiments, the one or more internal conductors include, without limitation, metals, carbon nanotubes, graphenes, carbons, and combinations thereof. In some embodiments, the one or more internal conductors include carbon nanotubes, such as carbon nanotube fibers. In some embodiments, the carbon nanotube fibers include threaded or intertwined carbon nanotube fibers.

In some embodiments, the one or more internal conductors include metals. In some embodiments, the metals include, without limitation, copper clad steel (CCS), tinned copper (TC), silver coated copper steel (SCCS), silver plated copper (SC), silver-covered nickel-covered copper-clad steel (SNCCS), and combinations thereof.

Carbon Nanotube Layers

The methods of the present disclosure may be utilized to form various types of carbon nanotube layers. In some embodiments, the one or more carbon nanotube layers include a network of interconnected carbon nanotubes. In some embodiments, the one or more carbon nanotube layers include bundled carbon nanotubes. In some embodiments, the one or more carbon nanotube layers include unidirectionally aligned carbon nanotubes. In some embodiments, the unidirectionally aligned carbon nanotubes are aligned along an axis of a substrate (e.g., coating direction of an internal insulating layer of a cable). In some embodiments, the unidirectionally aligned carbon nanotubes are in the form of bundles.

In some embodiments, the one or more carbon nanotube layers include neat carbon nanotubes. In some embodiments, the one or more carbon nanotube layers uniformly and seamlessly cover a surface of a substrate (e.g., a surface of an insulating layer of a cable or flat substrate). In some embodiments, the one or more carbon nanotube layers completely cover an entire surface of a substrate (e.g., an entire surface of an insulating layer of a cable or flat substrate).

The carbon nanotube layers of the present disclosure may have various thicknesses. For instance, in some embodiments, the one or more carbon nanotube layers have a thickness ranging from about 1 μm to about 500 μm. In some embodiments, the one or more carbon nanotube layers have a thickness ranging from about 10 μm to about 90 μm. In some embodiments, the one or more carbon nanotube layers have a thickness ranging from about 10 μm to about 50 μm. In some embodiments, the one or more carbon nanotube layers have a thickness of about 10 μm, about 40 μm, or about 90 μm. In some embodiments, the one or more carbon nanotube layers are uniform in thickness throughout a surface of a substrate (e.g., an insulating layer of a cable or flat substrate).

In some embodiments, the one or more carbon nanotube layers of the present disclosure surround an entire outer surface of a substrate (e.g., outer surface of a cable dielectric or insulating layer of a flat substrate). In some embodiments, the one or more carbon nanotube layers are in direct contact with a surface of a substrate (e.g., a surface of one or more internal insulating layers of a cable).

The carbon nanotube layers of the present disclosure can serve various purposes. For instance, in some embodiments, the one or more carbon nanotube layers serve as an outer conductor layer of a cable. In some embodiments, the one or more carbon nanotube layers serve as an electromagnetic shielding layer of a cable or an insulating substrate (e.g., a flat insulating substrate).

The carbon nanotube layers of the present disclosure can have various concentrations of carbon nanotubes. For instance, in some embodiments, the one or more carbon nanotube layers have a carbon nanotube content ranging from about 50% by weight to about 90% by weight. In some embodiments, the one or more carbon nanotube layers have a carbon nanotube content of more than about 50% by weight. In some embodiments, the one or more carbon nanotube layers have a carbon nanotube content of more than about 75% by weight. In some embodiments, the one or more carbon nanotube layers have a carbon nanotube content of more than about 90% by weight.

Control Over Thickness of Carbon Nanotube Layers

In some embodiments, the methods of the present disclosure also include a step of controlling a thickness of the one or more carbon nanotube layers. For instance, in some embodiments, the thickness of the one or more carbon nanotube layers is controlled by adjusting the carbon nanotube concentration in the carbon nanotube solution. In some embodiments, the lowering of the carbon nanotube concentration in the carbon nanotube solution results in formation of thinner carbon nanotube layers. In some embodiments, increasing carbon nanotube concentrations in the carbon nanotube solution results in formation of thicker layers of carbon nanotubes.

In some embodiments, the thickness of the one or more carbon nanotube layers is controlled by adjusting the coating speed. In some embodiments, a higher coating speed results in the formation of thicker carbon nanotube layers. In some embodiments, a lower coating speed results in the formation of thinner carbon nanotube layers.

In some embodiments, an adaptor is attached to a coating die to alter the gap between a surface of the substrate to coat (e.g., cable dielectric) and the wall of the adaptors. In some embodiments, this set-up allows for the control of the thickness of the one or more carbon nanotube layers. In some embodiments, different thicknesses of carbon nanotube layers may be utilized to improve the electrical conductivity of the formed carbon nanotube layers on a substrate (e.g., cable dielectric).

Solvent Removal

In some embodiments, the methods of the present disclosure also include a step of removing a solvent from carbon nanotubes (e.g., carbon nanotube layers deposited on a surface of a substrate, such as the surface of one or more cable dielectrics or flat substrates). In some embodiments, the solvent is removed after the formation of one or more carbon nanotube layers on a surface of a substrate (e.g., a surface of a flat substrate or a cable dielectric).

Various methods may be utilized to remove solvents from carbon nanotubes. In some embodiments, solvent removal occurs by coagulation. In some embodiments, coagulation removes the solvent (e.g., acid) and densifies the one or more carbon nanotube layers around a surface of a substrate (e.g., a cable dielectric or on the top of an insulating substrate). In some embodiments, coagulation occurs by exposure of the carbon nanotubes to a coagulant. In some embodiments, the coagulant includes, without limitation, water, hexane, ether, isopropanol, diethyl ether, poly(ethylene glycol) (e.g., PEG-200), dimethyl sulfoxide (DMSO), poly(vinyl alcohol), sulfuric acid, dichloromethane, trichloromethane, chloroform, acetone, tetrachloroethane, sulfolane, Triton-X, polymerizable monomers, N-methyl pyrrolidone (NMP), alcohols, methanol, ethanol, propanol, and combinations thereof. In some embodiments, the coagulant includes aqueous sulfuric acid. In some embodiments, the coagulant is ether or acetone.

In some embodiments, solvent removal occurs by evaporation of the solvent. In some embodiments, the evaporation of the solvent occurs by microwave heating, vacuum, dry spinning, and combinations thereof.

Additional methods of solvent removal can also be envisioned. For instance, in some embodiments, solvent removal steps disclosed in U.S. patent application Ser. No. 12/740,529 can be utilized to remove a solvent from carbon nanotubes.

Washing

In some embodiments, the methods of the present disclosure also include a step of washing the carbon nanotubes. In some embodiments, the carbon nanotubes are washed after the formation of one or more carbon nanotube layers. In some embodiments, the carbon nanotubes are washed before, during or after the formation of one or more carbon nanotube layers. In some embodiments, the carbon nanotubes are washed during or after a coagulation step in order to remove residues of coagulants from the carbon nanotubes.

Various methods may be utilized to wash carbon nanotubes. For instance, in some embodiments, the carbon nanotubes are washed by exposure to a washing solution. In some embodiments, the washing solution is water. In some embodiments, the washing solution is isopropanol. In some embodiments, washing occurs by exposure of the carbon nanotube layer to more than one washing solution. For instance, in some embodiments (e.g., embodiments where carbon nanotubes have been coagulated with ether), the carbon nanotubes are washed by sequential exposure to isopropanol and water.

Carbon nanotubes may be exposed to washing solutions by various methods. For instance, in some embodiments, carbon nanotubes are immersed in a container that includes the washing solution (e.g., a water bath).

Drying

In some embodiments, the methods of the present disclosure also include a step of drying the carbon nanotubes. In some embodiments, the carbon nanotubes are dried after the formation of one or more carbon nanotube layers on a surface of a substrate (e.g., a cable dielectric or flat substrate). In some embodiments, the carbon nanotubes are dried after the formation of one or more carbon nanotube layers. In some embodiments, the carbon nanotubes are dried after a coagulation step. In some embodiments, the carbon nanotubes are dried after a washing step.

Various methods may be utilized to dry carbon nanotubes. For instance, in some embodiments, the drying occurs by air drying. In some embodiments, the drying occurs by oven drying. Additional methods of drying carbon nanotubes can also be envisioned.

Association of Substrates with an External Insulating Layer

In some embodiments, the methods of the present disclosure also include a step of associating a carbon nanotube-coated substrate (e.g., an insulating substrate or a CNT-coated cable dielectric) with one or more external insulating layers. In some embodiments, the external insulating layers become directly associated with one or more carbon nanotube layers. In some embodiments, the association occurs by extrusion. For instance, in some embodiments, the association occurs by direct extrusion of one or more external insulating layers onto one or more carbon nanotube layers. In some embodiments (e.g., embodiments where one or more carbon nanotube layers have formed on a surface of an insulating layer of a cable component), the association results in the formation of a cable.

In some embodiments, the external insulating layer includes, without limitation, a polyvinyl chloride (PVC) jacket, rubbers, FG braids, fluorinated ethylene propylene (FEP), neoprene, and combinations thereof. In some embodiments, the external insulating layer can include standard cable insulator materials. In some embodiments, the external insulating layer is a PVC jacket.

Carbon Nanotube-Coated Substrates

Additional embodiments of the present disclosure pertain to carbon nanotube-coated substrates. In some embodiments, the carbon nanotube-coated substrates are formed in accordance with the methods of the present disclosure. In some embodiments, the carbon nanotube coated substrates of the present disclosure include one or more carbon nanotube layers that are derived from a carbon nanotube solution of the present disclosure.

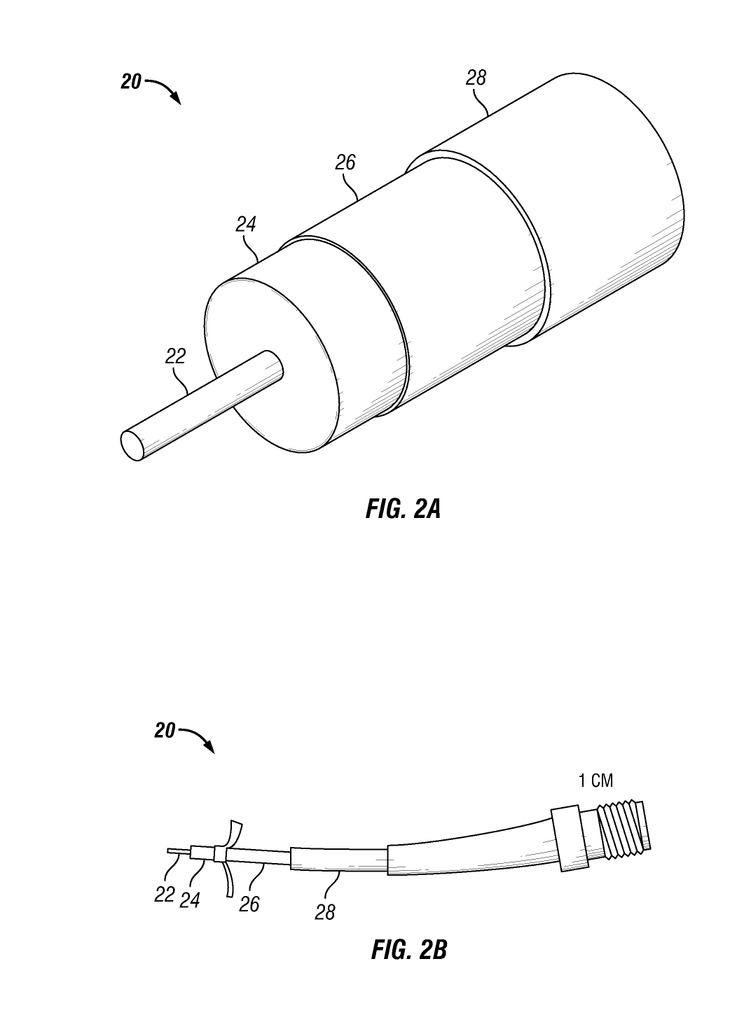

In some embodiments, the carbon nanotube-coated substrates of the present disclosure are assembled to form of a cable. In some embodiments illustrated in FIGS. 2A and 2B, the carbon nanotube-coated substrates of the present disclosure are components of cable 20 that include one or more internal conductors 22, one or more internal insulating layers 24, and one or more carbon nanotube layers 26. In some embodiments, cable 20 also includes one or more external insulating layers 28. In some embodiments, internal insulating layers 24 and carbon nanotube layers 26 represent the carbon nanotube-coated substrate.

As set forth in more detail herein, the carbon nanotube-coated substrates (e.g., cable components and insulating substrates) of the present disclosure can have various arrangements, structures, and compositions.

Substrates

Carbon nanotubes may be coated onto the surfaces of various substrates. Suitable substrates were described previously. For instance, in some embodiments, the substrate is in the form of a sheet that includes a front surface and a back surface. In some embodiments, the carbon nanotube layers are on at least one of the front surface and the back surface of the substrate. In some embodiments, the one or more carbon nanotube layers are on each of the front surface and the back surface of the substrate. In some embodiments, the carbon nanotube-coated substrates are in the form of double-sided shielded tapes. In some embodiments, the carbon nanotube-coated substrates of the present disclosure are insulating substrates.

In some embodiments, the substrate may be a component of a cable (e.g., internal insulating layers 24 of cable 20, as illustrated in FIGS. 2A-B). In some embodiments, the cable includes one or more internal conductors, and one or more internal insulating layers surrounding a surface of the one or more internal conductors (e.g., internal insulating layers 24 and internal conductors 22 of cable 20, as illustrated in FIGS. 2A-B). In some embodiments, the substrate represents the one or more internal insulating layers of the cable. In some embodiments, the one or more carbon nanotube layers are on a surface of the one or more internal insulating layers.

Suitable internal insulating layers and internal conductors have been described previously. For instance, in some embodiments, the one or more internal conductors include, without limitation, metals, carbon nanotubes, graphenes, carbons, and combinations thereof. In some embodiments, the one or more internal conductors include carbon nanotubes, such as carbon nanotube fibers in a twisted or coaxial configuration. In some embodiments, such carbon nanotube fibers can be used as inner conductors for cables.

Carbon Nanotube Layers

The carbon nanotube-coated substrates of the present disclosure may include one or more carbon nanotube layers in various arrangements (e.g., carbon nanotube layer 26 in FIGS. 2A-B). Suitable carbon nanotube layers were described previously. For instance, in some embodiments, the one or more carbon nanotube layers include dispersed carbon nanotubes, a network of interconnected carbon nanotubes, bundled carbon nanotubes, unidirectionally aligned carbon nanotubes that are aligned along an axis of the substrate (e.g., axis of the cable), neat carbon nanotubes, and combinations thereof.

In some embodiments, the one or more carbon nanotube layers uniformly and seamlessly cover a surface of a substrate (e.g., a surface of a cable dielectric or a flat substrate). In some embodiments, the one or more carbon nanotube layers completely cover the entire surface of a substrate (e.g., a cable dielectric or a flat substrate). In some embodiments, the one or more carbon nanotube layers are uniform in thickness throughout a surface of a substrate (e.g., a cable dielectric or flat substrate).

In some embodiments, the one or more carbon nanotube layers of the present disclosure surround an entire outer surface of a substrate (e.g., a cable dielectric or flat substrate). In some embodiments, the one or more carbon nanotube layers serve as an outer conductor layer. In some embodiments, the one or more carbon nanotube layers serve as an electromagnetic shielding layer.

In some embodiments, the one or more carbon nanotube layers are on a surface of one or more internal insulating layers. In some embodiments, the one or more carbon nanotube layers are in direct contact with the one or more internal insulating layers (e.g., carbon nanotube layer 26 in direct contact with the surface of internal insulating layer 24, as shown in FIGS. 2A-B).

The carbon nanotube layers of the present disclosure can also have various concentrations of carbon nanotubes (as previously described). Moreover, the carbon nanotube layers of the present disclosure may be derived from various carbon nanotube solutions (as also described previously).

External Insulating Layer

In some embodiments, the carbon nanotube-coated substrates of the present disclosure may also be associated with one or more external insulating layer. In some embodiments, the cables made out of carbon nanotube-coated substrates of the present disclosure can also include one or more external insulating layers (e.g., external insulating layer 28, as shown in FIGS. 2A-B). Suitable external insulating layers have also been described previously. In some embodiments, the one or more external insulating layers are in direct contact with the one or more carbon nanotube layers (e.g., external insulating layer 28 being in direct contact with carbon nanotube layer 26, as shown in FIG. 2).

Structures and Arrangements

The carbon nanotube-coated substrates of the present disclosure can have various structures and arrangements. For instance, in some embodiments, the carbon nanotube-coated substrates of the present disclosure are in the form of a flat substrate. In some embodiments, the carbon nanotube-coated substrates of the present disclosure can have shapes that are circular, oval, square, hexagonal, rectangular, irregular, or combinations thereof. In some embodiments, the carbon nanotube-coated substrates of the present disclosure are one or more components of a cable (e.g., cable 20, as illustrated in FIGS. 2A-B). In some embodiments, the carbon nanotube-coated substrates of the present disclosure are one or more components of data cables, such as data cables with coaxial and twisted-pair geometries.

In some embodiments, the cables of the present disclosure have one or more carbon nanotube layers as cable outer conductor(s). In some embodiments, the cables can have one or more carbon nanotube wire(s) (e.g., bundles of carbon nanotube fibers, as previously described) as internal conductor(s). In some embodiments, the cable internal conductors include one or more metal conductors that have been coated with carbon nanotubes. In some embodiments, carbon nanotubes are coated on metal conductors by solution coating.

In some embodiments, the carbon nanotube-coated substrates of the present disclosure can be incorporated in cables of different types. For instance, in some embodiments, the cables can be coaxial cables. In some embodiments, the cables can be twisted pair cables. In some embodiments, the cables can be serial cables. In some embodiments, the cables can be USB cables. In some embodiments, the cables can be ribbon cables. In some embodiments, the cables can be twin-lead cables.

In various embodiments, the cables of the present disclosure can have any cross-section, including circular, square, rectangular (including flat as in a tape), oval, and combinations thereof. In some embodiments, the cables of the present disclosure can have irregular cross-sections that are formed by twisting together or otherwise combining individual insulated wires (e.g., insulated wires of circular cross section, square cross section, rectangular cross section, flat cross section, oval cross section, and combinations thereof).

Advantages

To Applicants' knowledge, a solution process to create a seamless layer of carbon nanotubes on a surface of a substrate (e.g., a cable dielectric) has not been demonstrated. As such, the methods of the present disclosure provide novel methods of making many carbon nanotube-coated substrates (e.g., as components of carbon nanotube shielded cables). Furthermore, the methods of the present disclosure are scalable, continuous and facile. For instance, in some embodiments, the methods of the present disclosure can occur without mechanical weaving or mechanical rolling. Furthermore, the methods of the present disclosure can be utilized to make bulk quantities of carbon nanotube-coated substrates (e.g., a components of cables) with various sizes and shapes.

Moreover, the formed carbon nanotube-coated substrates of the present disclosure (e.g., as component of cables) can have higher performance and lower weight than standard EM shielding layers. For instance, when compared to wires that contain a commercial metal mesh as an EM shielding layer, the carbon nanotube layers of the present disclosure can significantly decrease the weight of a cable (e.g., by about 50-80%) while still retaining the high conductivity required for EM shielding. In some embodiments where an internal conductor of a cable with a carbon nanotube-coated substrate includes one or more CNT fibers instead of a metallic wire, an 80% weight loss may be observed when compared to a commercial metal cable.

In some embodiments, the one or more carbon nanotube layers of a carbon nanotube-coated substrate have a weight ranging from about 0.01 g/m to about 0.5 g/m. In some embodiments, the one or more carbon nanotube layers of a carbon nanotube-coated substrate have a weight ranging from about 0.02 g/m to about 0.2 g/m. In some embodiments that are described in more detail in the Examples herein, a weight of about 0.18 g/m for a carbon nanotube layer that is about 90 μm thick has been achieved. The aforementioned weight has translated to a 97% weight saving for an outer conductor of a cable when compared to a commercial metal shielding braid, and a 50% weight saving for the overall cable (e.g., inner conductor, outer conductor, dielectric, and jacket). In some embodiments that are also described in more detail in the Examples herein, a weight of about 0.02 g/m for a carbon nanotube layer that is about 13 μm thick has been achieved. In some embodiments, the aforementioned weight has translated to a 99.6% weight saving for an outer conductor of a cable when compared to a commercial metal shielding braid, and more than a 50% weight saving for the overall cable (e.g., inner conductor, outer conductor, dielectric, and jacket).

The carbon nanotube-coated substrates of the present disclosure can also have various improved electrical properties. For instance, in some embodiments, the one or more carbon nanotube layers of a carbon nanotube-coated substrate have an electrical conductivity ranging from about 100 kS/m to about 700 kS/m. In some embodiments, the one or more carbon nanotube layers of a carbon nanotube-coated substrate have an electrical conductivity of about 650 kS/m.

In some embodiments, the one or more carbon nanotube layers of a carbon nanotube-coated substrate have a specific electrical conductivity (electrical conductivity normalized by density) ranging from about 1,000 Sm²/Kg to about 2,500 Sm²/Kg. In some embodiments, the one or more carbon nanotube layers of a carbon nanotube-coated substrate have a specific electrical conductivity ranging from about 1,500 Sm²/Kg to about 2,500 Sm²/Kg. Likewise, in some embodiments, the carbon nanotube-coated substrates of the present disclosure (e.g., as components in cables) have a specific conductivity of about 1,500 Sm²/kg. In some embodiments, the carbon nanotube layers of the carbon nanotube-coated substrates of the present disclosure (e.g., as components in cables) have an electrical conductivity of about 650 kS/m.

In some embodiments, the cables made out of carbon nanotube-coated substrates of the present disclosure have attenuation values of less than about 3 dB/m or less than about 90 dB/100 ft at 1 GHz. In some embodiments, the cables made out of carbon nanotube-coated substrates of the present disclosure have attenuation values of about 1.5 dB/m or about 45 dB/100 ft at 1 GHz. In some embodiments that are described in more detail in the Examples herein, the cables made out of carbon nanotube-coated substrates of the present disclosure (e.g., a cable with a metal inner conductor and a 90 μm thick carbon nanotube layer as an outer conductor) have attenuation values as low as 1.5 dB/m or 45 dB/100 ft at 1 GHz.

In some embodiments where the one or more carbon nanotube layers serve as an outer conductor of a cable, the direct current electrical resistance of the carbon nanotube-coated substrate does not substantially increase with repeated bending when the cable is tested by a 3-point bending mechanical test. In some embodiments, the insertion loss of a cable that includes a carbon nanotube coated substrate of the present disclosure (e.g., a cable with one or more carbon nanotube layers as the cable outer conductor) does not substantially increase with repeated bending. For instance, in some embodiments that are described in more detail in the Examples herein, it has been shown that a cable with the carbon nanotube coating as the cable outer conductor can undergo mechanical flex fatigue tests without showing any increase in direct current electrical resistance during the test. Moreover, no change in insertion loss (or transmission in alternated current) was detected before and after the test.

Furthermore, the carbon nanotube-coated substrates of the present disclosure (e.g., as components in cables) provide solution-coated layers of CNTs that are uniform in thickness, thereby providing optical coverage and hence high performance across the frequency spectrum. Likewise, the formed carbon nanotube-coated substrates of the present disclosure (e.g., as components in cables) can have properties that are better than literature examples at much lower CNT layer thicknesses. For instance, as described in more detail in Example 2, Applicants observed that a 13 micrometer solution coated carbon nanotube layer on a cable internal insulating layer (cable dielectric) had EM shielding properties that were comparable to the EM shielding properties of a 516 micrometer rolled CNT layer on a cable dielectric.

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Coating of Carbon Nanotube Solutions onto Cable Dielectrics or Flat Substrates

This Example illustrates that the coating of carbon nanotube (CNT) solutions onto internal insulating layers of cables or a flat substrates can be realized by several coating methods, including dip coating, wire coating, slot coating, slide coating, and knife coating.

### Example 1.1. Dip Coating

In an embodiment, a cable containing an internal insulating layer and an internal conductor (e.g., CNT fibers or a metallic wire) or a flat insulating substrate can be coated by dip coating. In a dip coating method, the CNT solution is contained in a container in which the wire to coat (e.g., cable internal insulating layer or flat layer) is immersed and then removed from the solution at controlled speed. The wire to be coated can be immersed from the top of the solution bath and then removed from the solution by a motorized arm, thereby allowing the deposition of the liquid film on the top of the wire (FIG. 3A).

Multiple wires can be immersed and removed in and from the bath at the same time. The process can then be followed by a series of coagulation and washing steps to remove the acid. This can be followed with one or more drying steps, such as oven drying or air drying. For instance, the coagulation and washing steps can be done by immersion in coagulation and washing baths followed by oven and air-drying.

Alternatively, a continuous dip coating process can be realized by pulling a wire (e.g., a flat wire/tape or cable internal insulating layer) by a roll immersed in a CNT solution bath (FIG. 3B). Next, the wire is extracted from the CNT solution by another roll outside the bath. The control over coating speed and solution concentration can determine the final CNT layer thickness. Moreover, the system can be adapted to coat multiple wires at the same time as they are rolled in parallel onto the rolls. In some instance where multiple wires are coated at the same time, the process can be equipped with a twisting machine in-line to twist the coated wire (e.g., cable internal insulating layers) and realize the twisted-pair cable geometry. Otherwise, the twisting can be done off-line. The coating process can also be repeated multiple times for either bath or continuous dip coating processes to achieve thicker coatings.

### Example 1.2. Wire Coating

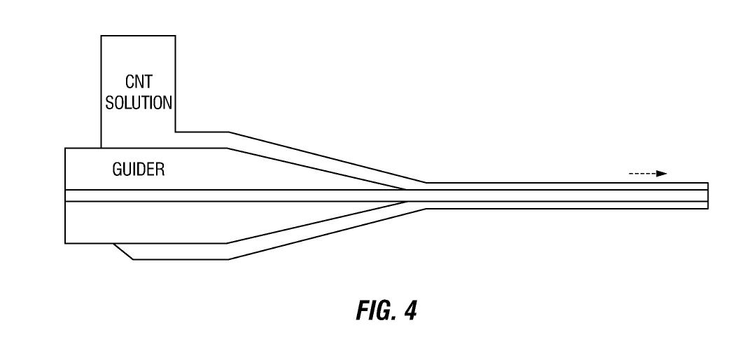

In an alternative embodiment, a wire (e.g. flat insulating layer or cable dielectric) can be coated by wire coating (FIG. 4). Depending on the shape of the wire to coat (e.g., circular or flat), the entrance and the exit of the cross-head die can have different shapes to adapt for the wire geometry. In this process, the CNT solution is contained in a chamber connected to the cross-head die and pushed in the cross-head die by a piston. The wire to coat is then fed from the back to the cross-head die through a guider tube. The wire can be kept in tension by rolls placed before the wire enters the cross-head die and after it exits the cross-head die. Once the wire exits from the guider, it is surrounded by the CNT solution and is uniformly coated all around. The cross-head die can also be heated or cooled as the wires enter the cross-head die.

The coated wire can first be exposed to an air gap and then to a coagulant for the removal of the acid after exiting from the cross-head die. The coated wire can also be directly exposed to the coagulant. The wire can enter the coagulant bath vertically, horizontally or under an angle. The coagulant bath can be one bath or multiple baths in series to remove gradually the acid and wash the coated wire. The wire can then be dried in-line using an oven placed after the coagulation bath. The wire can also be air dried.

### Example 1.3. Slot Coating

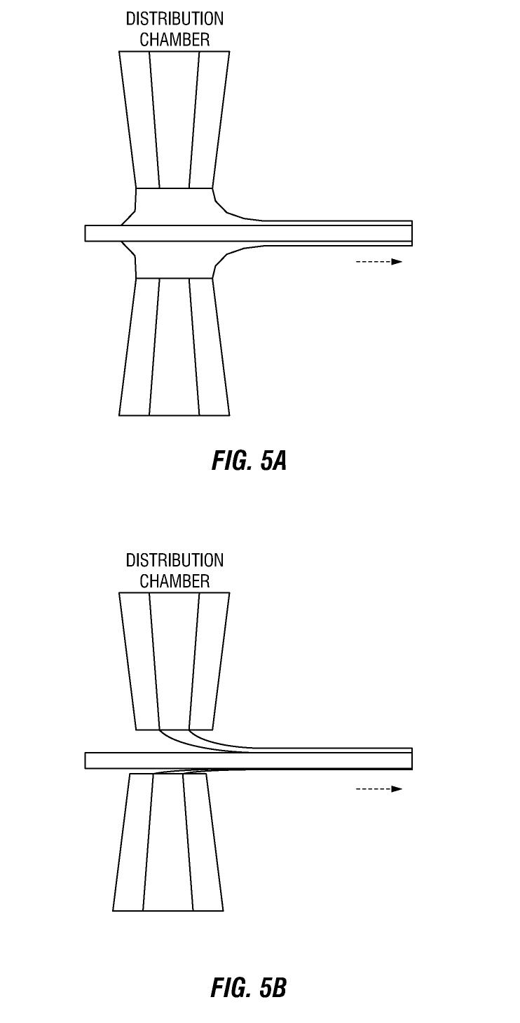

In an alternative embodiment, a wire (e.g., a flat insulating substrate) could be coated by slot coating or extrusion coating (FIGS. 5A-B) in order to realize a double-side shielded tape. In this case, the CNT solution is contained in two distribution chambers placed on the top and bottom of the wire to coat with a lower aperture that allows the solution to be extruded on the moving wire. The die and the wire can both be heated or cooled. The moving wire can be pulled by a roll that directs the coated wire to coagulation and washing baths. The coated wire can then be air dried or dried with an in-line oven.

### Example 1.4. Slide Coating

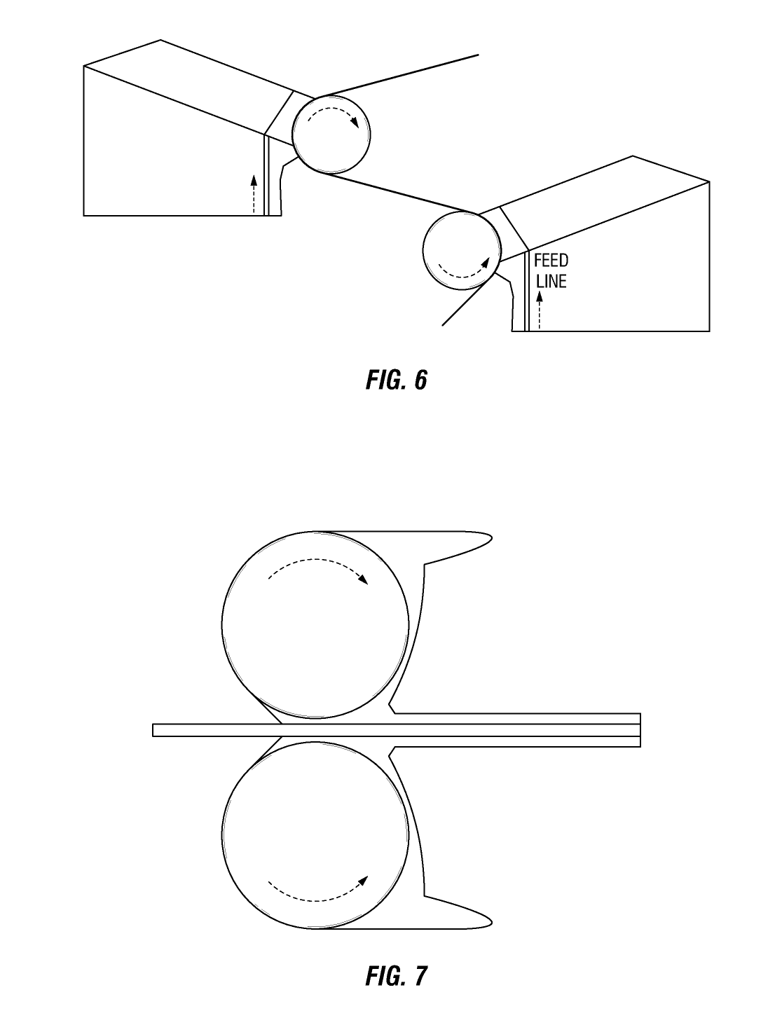

In another embodiment, a flat substrate could be coated by slide coating (FIG. 6) in order to realize a double-side shielded tape. The wire to coat is supported by a backing roll and in close proximity of two multilayer dies with an inclined plane. The CNT solution is fed to the inclined plane from cavities and slots beneath the plane. Once the CNT solution reaches the web to coat sliding down the inclined plane, it wets the moving web. Next, a liquid layer is deposited on the top of the wire. The die can then be heated or cooled as well as the wire. The wire is then pulled through a series of rolls into coagulation and washing baths. The coagulation and washing baths can also be places between the two coating slides. The coated wire can then be air dried or dried with an in-line oven.

### Example 1.5. Knife Coating

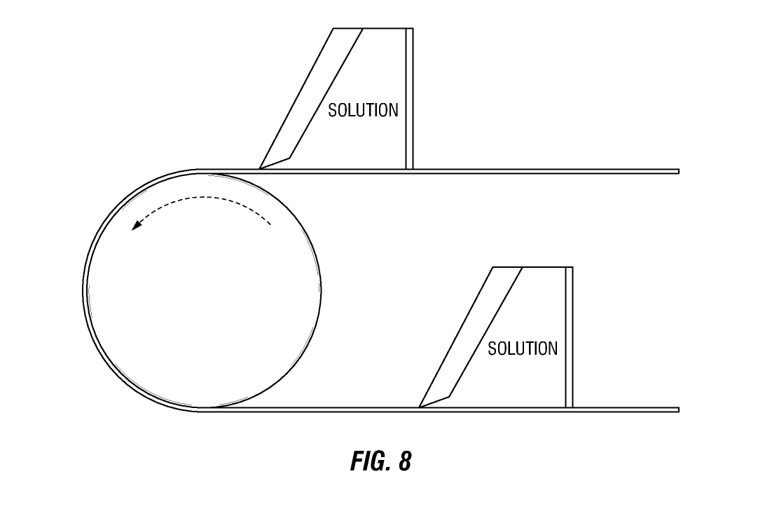

In another embodiment, a flat substrate could be coated by knife coating (FIG. 7) in order to realize a double-side shielded tape. In this example, the CNT solution is fed on a moving web (i.e., the insulating substrate to coat) and then metered by a knife kept in close proximity to the top and bottom wire surfaces. The die and the wire can both be heated or cooled. The thickness of the coating can be varied depending on the distance of the knife from the surface of the web and the geometry of the gap. The wire is then pulled by a rotating roll into coagulation and washing baths. Thereafter, the wire is air dried or dried with an in-line oven.

### Example 1.6. Roll Coating

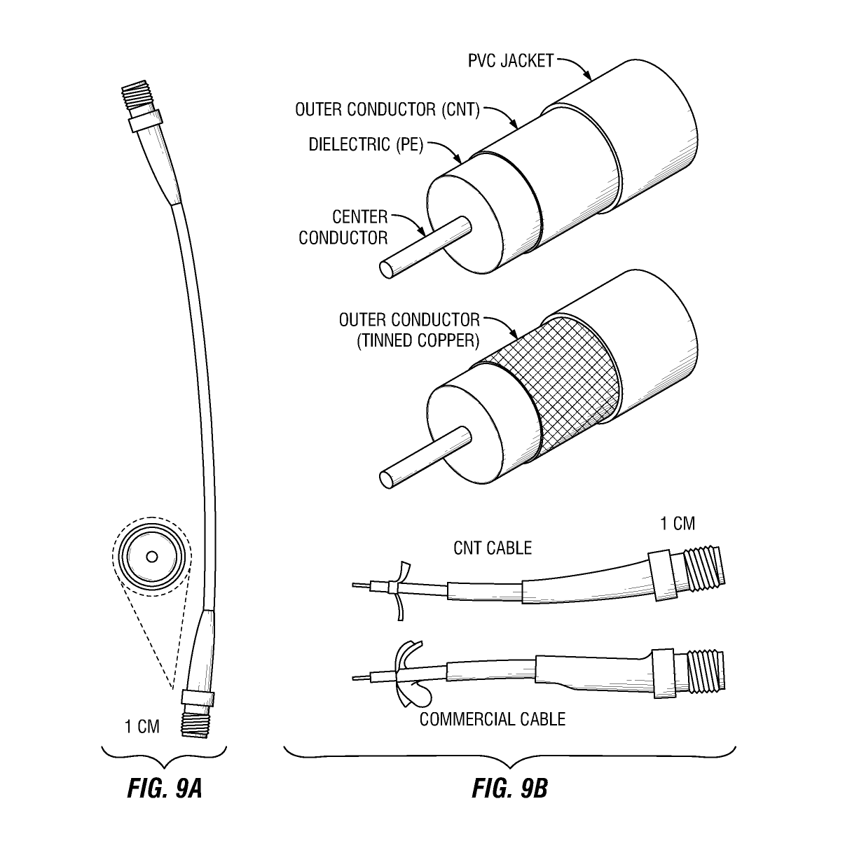

In an alternative embodiment, a flat substrate could be coated by roll coating (FIG. 8) in order to realize a double-side shielded tape. In this Example, the wire can move between two rotating rolls separated by a gap in which the fluid is confined. The die and the substrate can be heated or cooled. The thickness of the coating could depend on the gap between the rolls, the substrate surface, and the roll speed. The coated substrate is then pulled through a series of rolls into coagulation and washing baths. Thereafter, the coated substrate is air dried or dried with an in-line oven.

### Example 2. Lightweight, Flexible, High-Performance Carbon Nanotube Shielded Cables by Scalable Flow Coating

Coaxial cables for data transmission are ubiquitously used in telecommunications, aerospace, automotive and robotics industries and are equipped with an electromagnetic (EM) shield to minimize the crosstalk between coaxial data cables and outside interference. EM shielding is often the heaviest component of modern data cables. Therefore, exchanging the conventional metal shielding for lower weight materials with comparable transmission characteristics and performance is highly desirable. Carbon nanotubes (CNTs) combine gigapascal mechanical strength, high electrical and thermal conductivity with low density, which makes them ideal for applications where weight saving is a priority. Here, a solution of CNTs in chlorosulfonic acid (CSA) is used to fabricate the EM shield of coaxial data cables. When compared to commercial cables with metal (tin-coated copper) EM shielding, the carbon nanotube coaxial data cables have comparable cable attenuation and mechanical durability but a 97% lower component mass.

Coaxial cables are indispensable in modern technology and have a wide range of uses that span from navigation to telecommunication systems. These cables consist of a center conductor, an insulating layer (dielectric), and an electromagnetic (EM) shield (outer conductor) to minimize the EM interference. Metals are generally used as conductors because of their high conductivity, but have high density and limited fatigue resistance, which requires complex (braided) shielding architectures and wire oversizing to meet mechanical specifications. Replacing the metals in conventional coaxial cables with lighter, fatigue-resistant materials has been preferred particularly in aerospace applications where weight reduction affects directly launch cost and fuel efficiency. In commercial and military aircrafts, as well as satellites and spacecrafts, this can lead to improved travel range, mission time, and reduced emissions. Despite over three decades of research, composite core-skin metal-polymer constructs (such as metallized PPTA (Aracon) and PBO (Amberstrand)) provide only minor advances and have limited operating ranges because of issues such as delamination.

In this Example, Applicants show that solution coated CNT shielding layers combine high electrical functionality, flexibility, and scalable manufacturing. Applicants show that a coaxial cable consisting of an inner copper conductor and CNT shielding can meet military standards for data transmission at 1 GHz and have comparable flex fatigue resistance to commercial cables with an outer conductor linear mass 97% lighter that its metal counterpart, a stunning weight saving.

### Example 2.1. Cable Fabrication

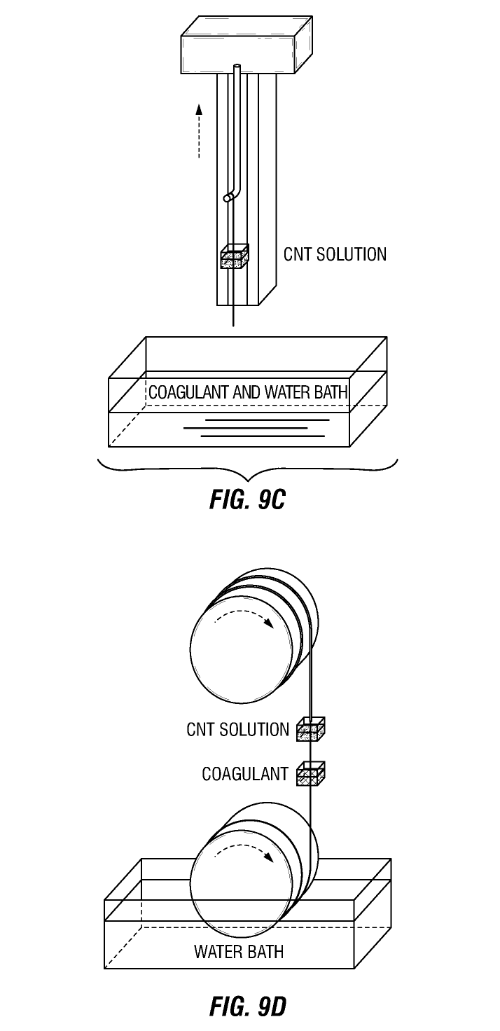

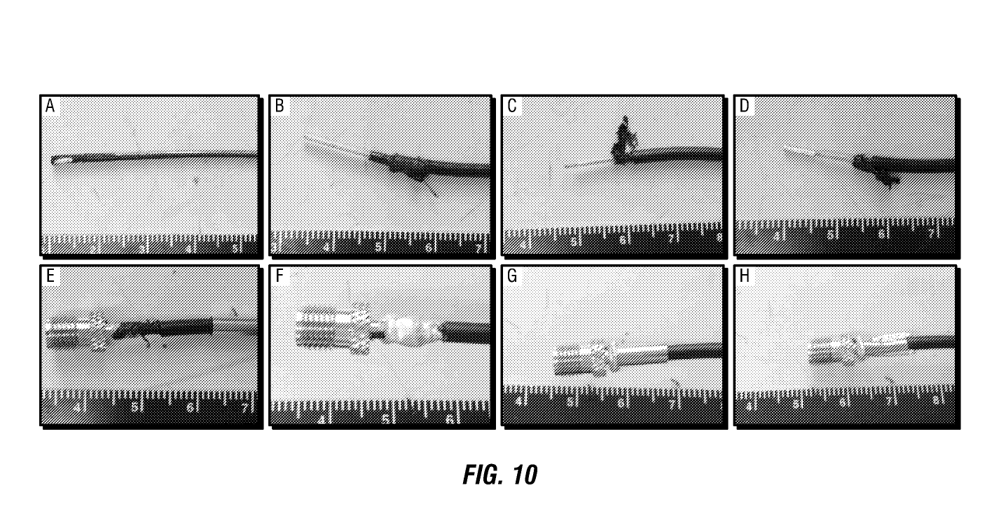

The CNT coaxial cables were fabricated from RG174U coax (FIG. 9A) and subsequently attached to female SMA connectors (FIG. 10). In both CNT and commercial cables, a copper wire serves as the inner conductor and is coated by a polyethylene (PE) dielectric (FIG. 9B). The dielectric is covered by the outer conductor, which is a metal braid for the commercial cables and a CNT layer in CNT cables (FIG. 9B). Both cables are insulated by nominally identical PVC jackets. CNTs were solution coated onto the cable PE dielectric by two methods: (1) discrete dip coating using a solution of CNTs in chlorosulfonic acid (CSA) (FIG. 9C), followed by coagulation, washing in water, and overnight air drying; (2) continuous roll-to-roll wire coating (FIG. 9D) with inline deposition of a CNT-CSA solution, coagulation, water washing and off-line overnight air drying.

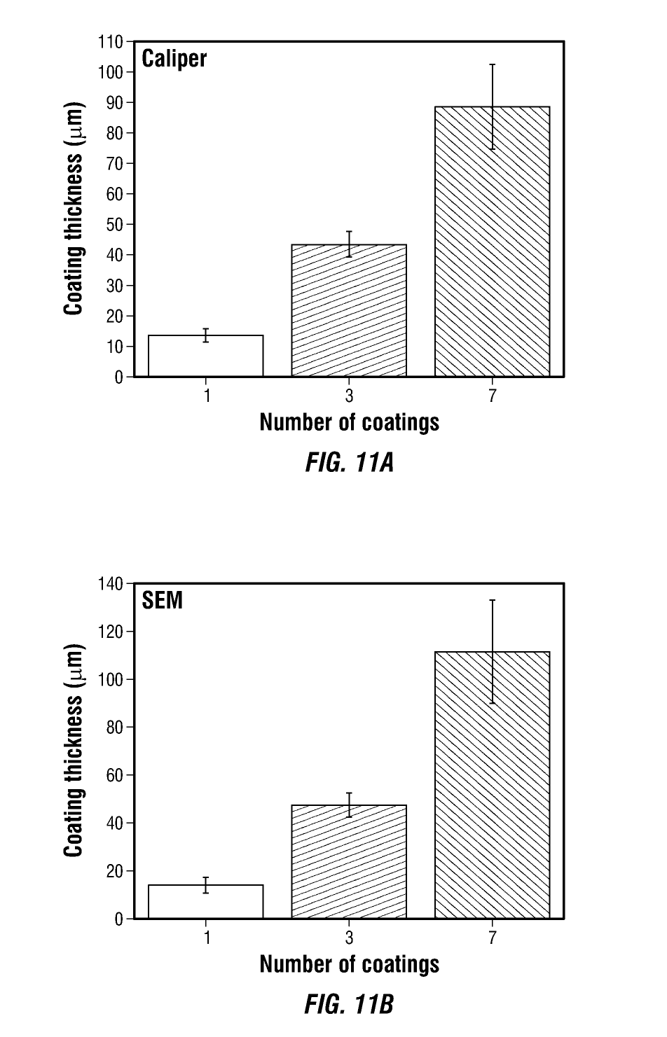

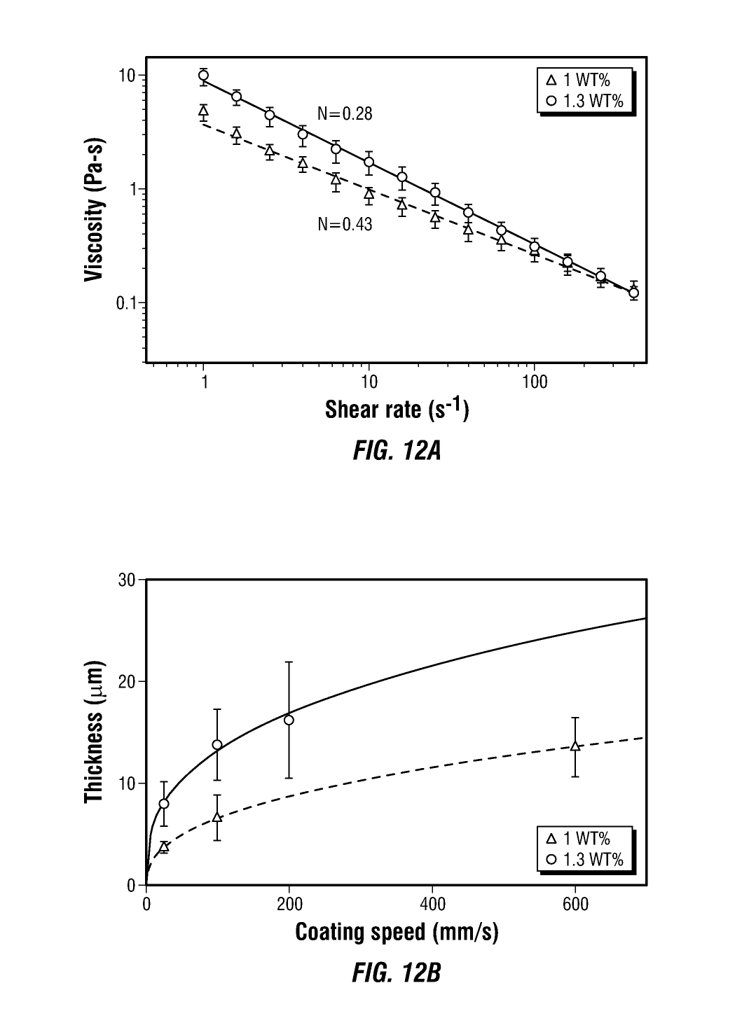

Applicants produced the CNT cables described here using approach (1). However, method (2) (FIG. 9D) may be better suited for industrial manufacturing. For Applicants' cables, Applicants controlled the CNT layer thickness by coating the cable multiple times (FIG. 11), yielding CNT layer thicknesses of (13±2) μm, (43±4) μm, and (90±14) μm. Industrial processes (FIG. 9D) could control thickness by tuning coating rate and solution viscosity. Indeed, higher solution viscosity and withdrawal rate lead to thicker coating as predicted by Gutfinger and Tallmadge's model (FIG. 12) where coating thickness h_{dry} is related to the withdrawal speed u by the power law relation:

$${h}_{dry} ∼ {u}^{\frac{2 n}{( 2 n + 1 )}} .$$

In this relation, n is the power law exponent from η=K\dot{γ}ⁿ⁻¹ where η is the fluid viscosity, \dot{γ} is the shear rate, and K is the consistency index. The (2n/(2n+1)) exponent obtained by rheology showed a 3-15% agreement with n obtained by fitting the coating thickness values to the Gutfinger and Tallmadge's model.

### Example 2.2. Coating Morphology

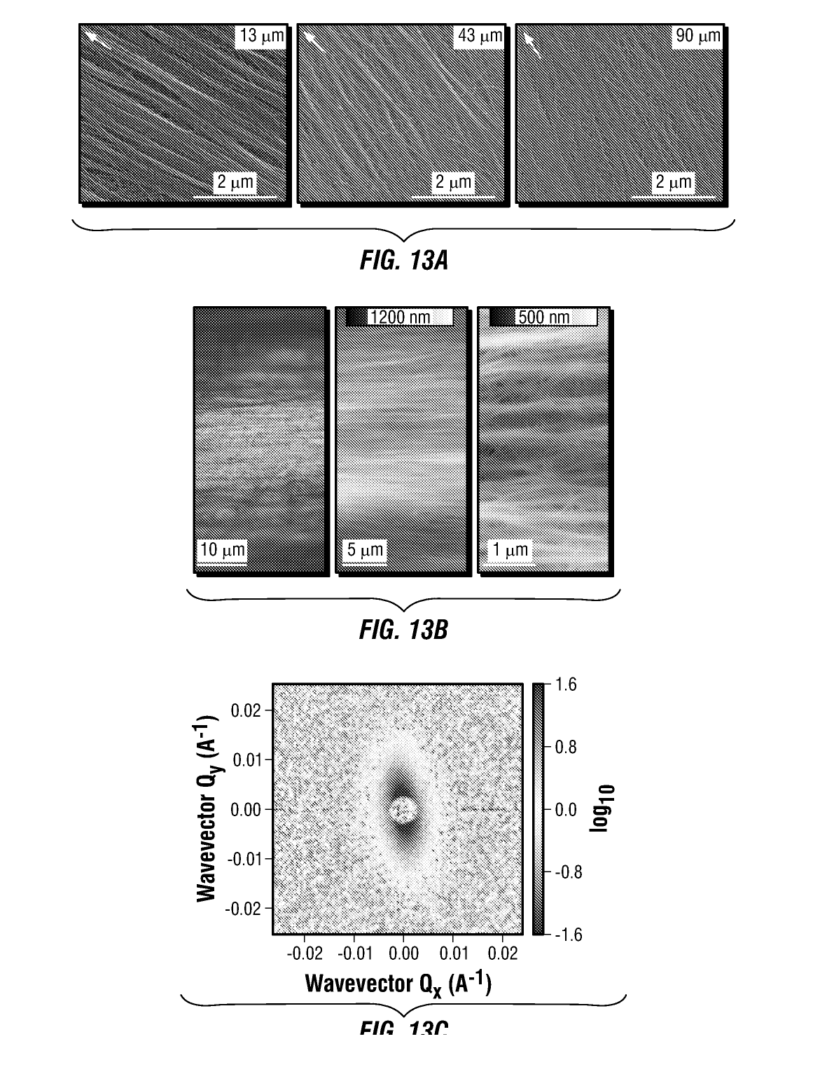

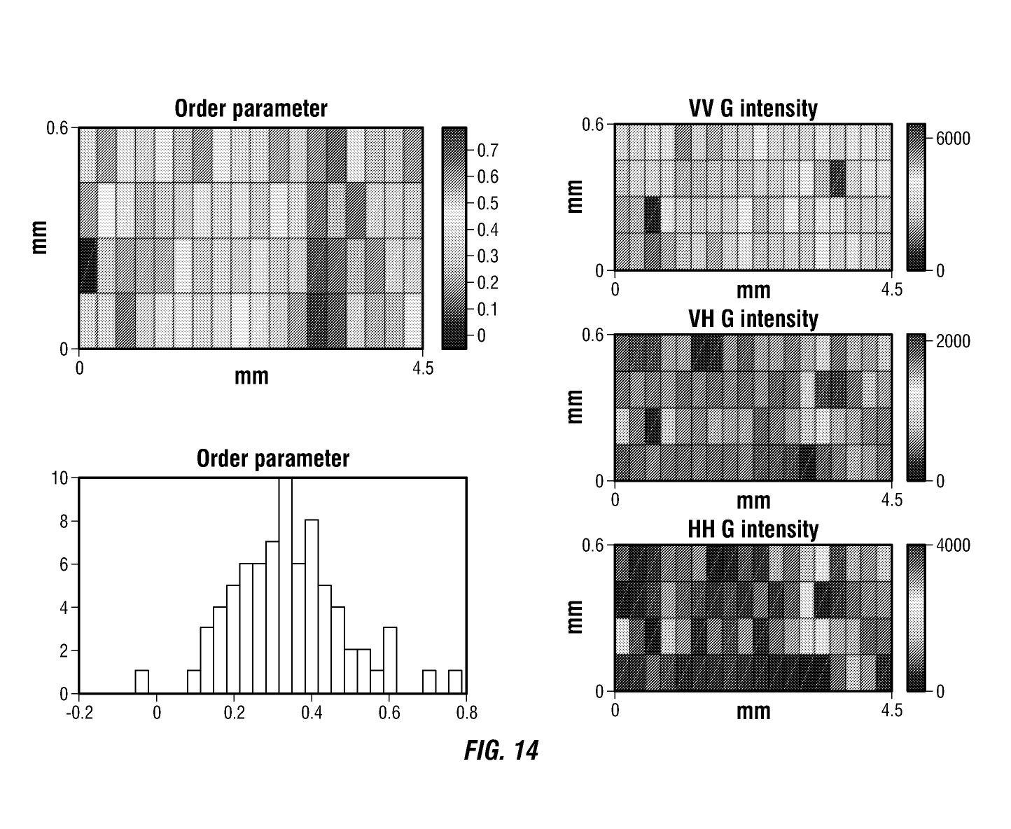

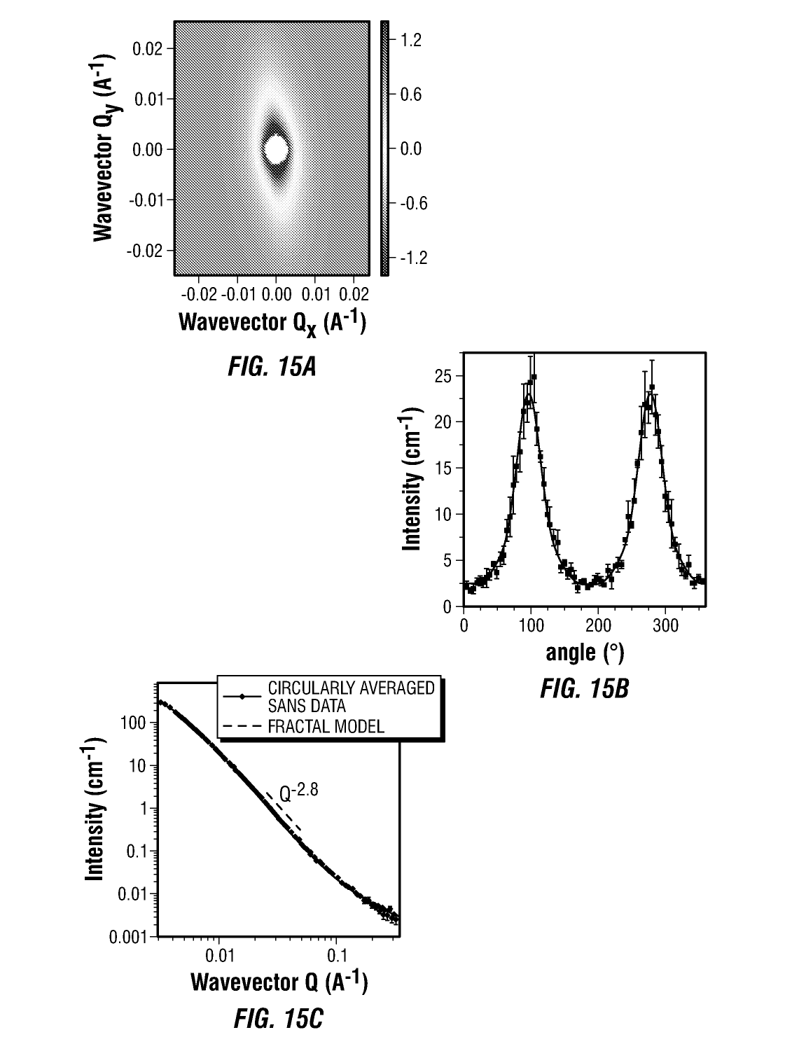

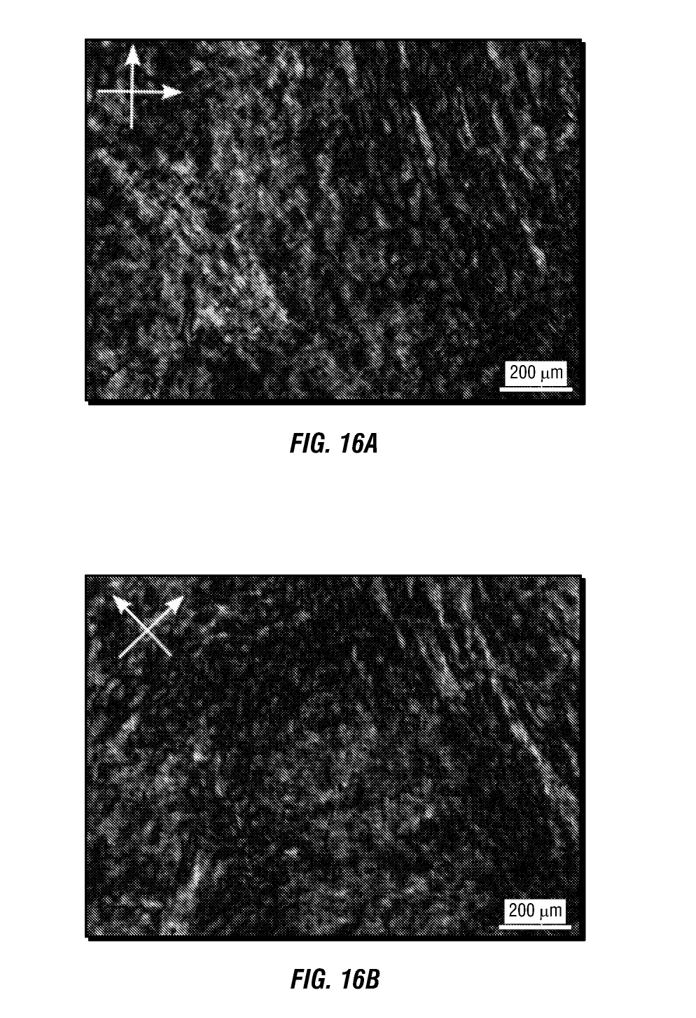

To investigate the local morphology and structure of the CNT layer onto the cable dielectric, Applicants used scanning electron microscopy (SEM), atomic force microscopy (AFM), small-angle neutron scattering (SANS), and polarized Raman spectroscopy. SEM (FIG. 13A) and AFM (FIG. 13B) indicated the presence of CNT bundles oriented parallel to the draw direction. The strong Raman signal (FIG. 14) along the cable demonstrated the absence of uncoated areas and the average order parameter of the CNT coating was found to be 0.34±0.14. SANS measurements on the CNT coating confirmed the bundle alignment along the cable axis and showed clear orientational order for length scales greater than 10 nm, which is attributed to CNT bundles forming dense CNTs networks (FIGS. 13C and 15). The SANS signal was fitted to a 2D model of aligned fibers, yielding an average fiber diameter of approximately 45 nm (FIG. 15A). The degree of fiber alignment was quantified from annular averages of the 2D scattering profile resulting in the intensity spectrum shown in FIG. 15B. The alignment angle and the angular distribution were obtained from fits to a Gaussian distribution of the hump-like structures (FIG. 15B) and were found to be 98° (mod π) and 20.4° (standard deviation), respectively. The alignment factor of the CNT bundles was obtained from fits of the 1D annularly-averaged data (FIG. 15B) and was found to be ˜0.323, in agreement with the order parameter found by polarized Raman. The alignment factor value found is common in aligned soft matter systems, including fibrins, worm-like micelles and polymers. The strong CNT alignment along the cable axis is consistent with the shear applied in the draw direction and the liquid crystalline nature of the CNT solution (FIG. 16) caused by high CNT aspect ratio (˜4,000) and solution concentration (1.3% by mass).

### Example 2.3. Cable Mechanical Properties

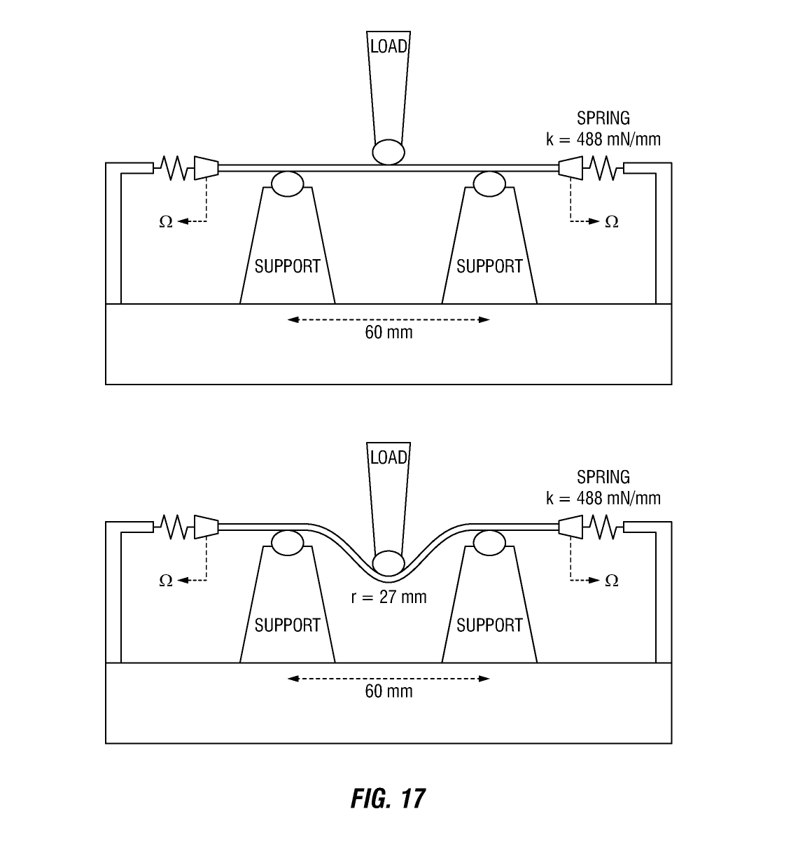

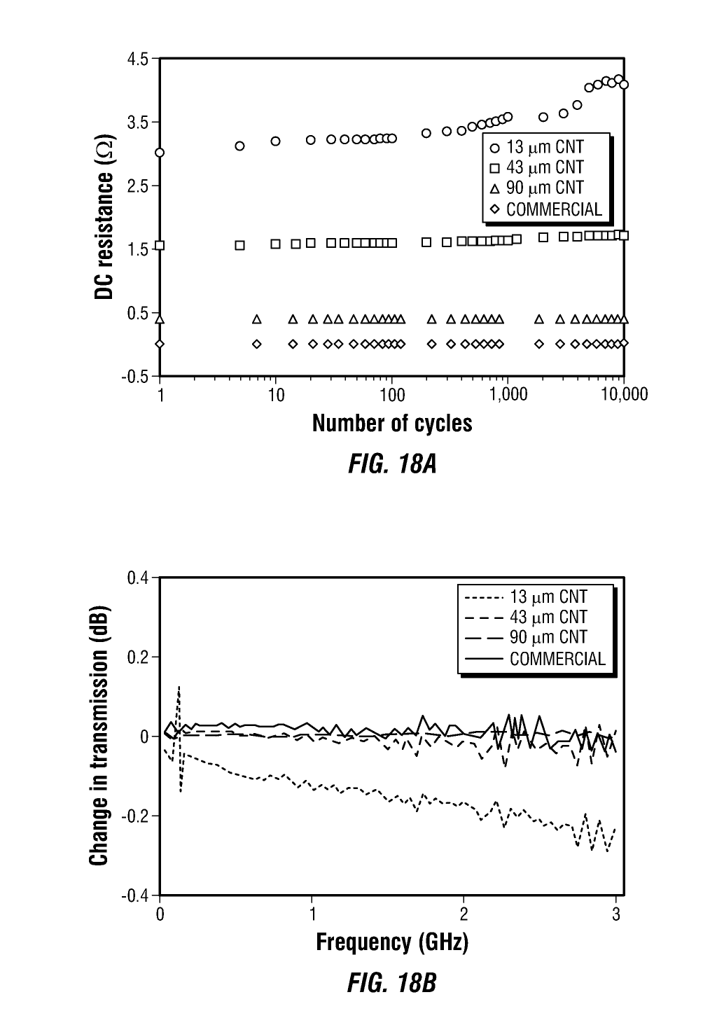

In order to evaluate if changing the cable outer conductor material weakens the cable structure, Applicants performed a fatigue test in a three-point geometry (set up shown in FIG. 17) on 14.2 cm long cables for commercial and CNT cables with the three coating thicknesses described above. During the test, the direct current (DC) resistance of the CNT layer was measured as a function of bending cycles (FIG. 18A). Before and after the bending test, Applicants characterized the transmission (or insertion loss) as a function of frequency (FIG. 18B). The DC resistance increased with an increasing number of cycles for the cables with thin CNT layers ((13±2) μm and (43±4) μm), but the effect of fatigue was negligible for (90±14) μm thick CNT coating and commercial cables after 10,000 cycles. Consistent with the DC measurements, Applicants found that the change in transmission rapidly approached those of commercial cables as the thickness of the CNT coating increased (FIG. 18B). Commercial cables did not fatigue since their metal mesh is designed to endure the bend radius, whereas the thinner CNT coatings were damaged by the dielectric plastic deformation. Conversely, the (90±14) μm thick CNT layer did not experience a decrease in electrical performance after repeated bending due to the reinforcement of the cable jacket that tightly enveloped the CNT layer. In fact, the increased thickness allowed the reduction of the gap between CNT coating and PVC jacket, while the (13±2) μm coating was too thin to be in close contact with the PVC jacket.

### Example 2.4. Cable Electrical Properties

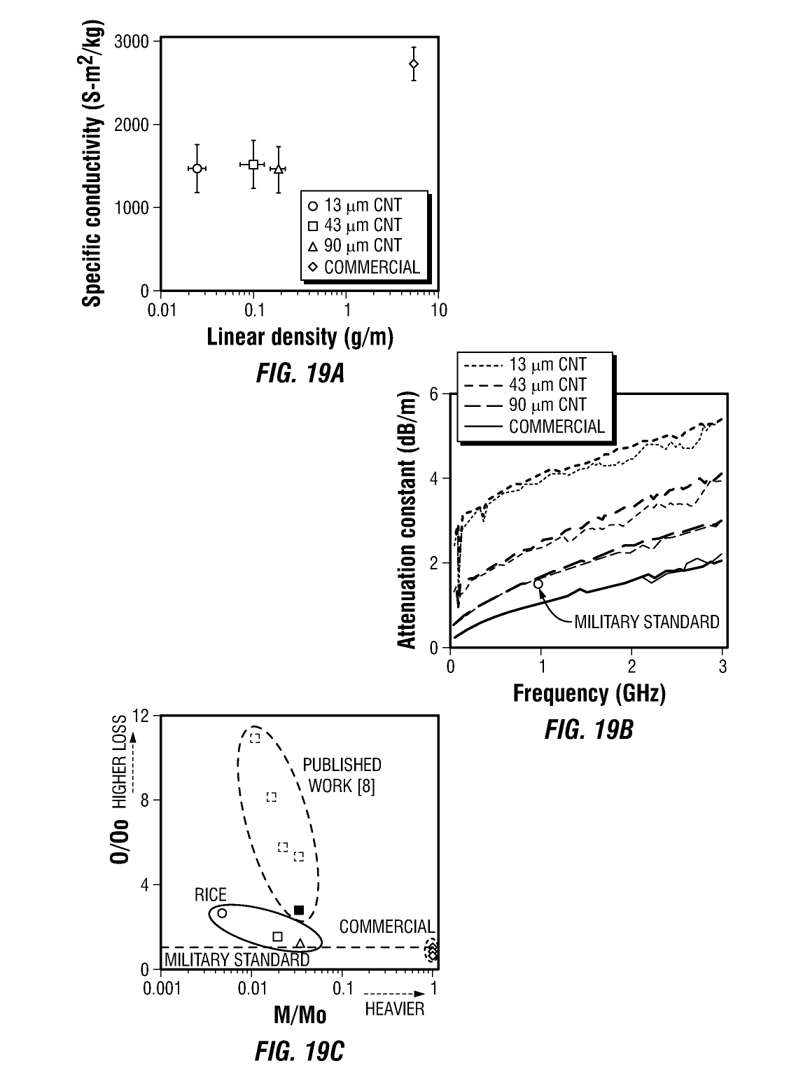

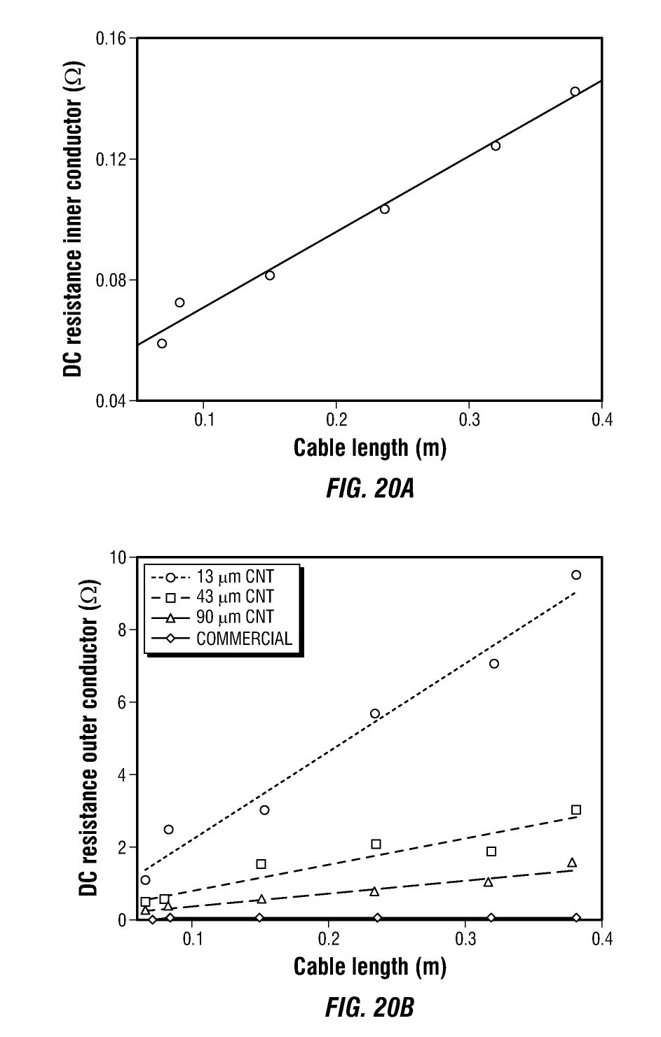

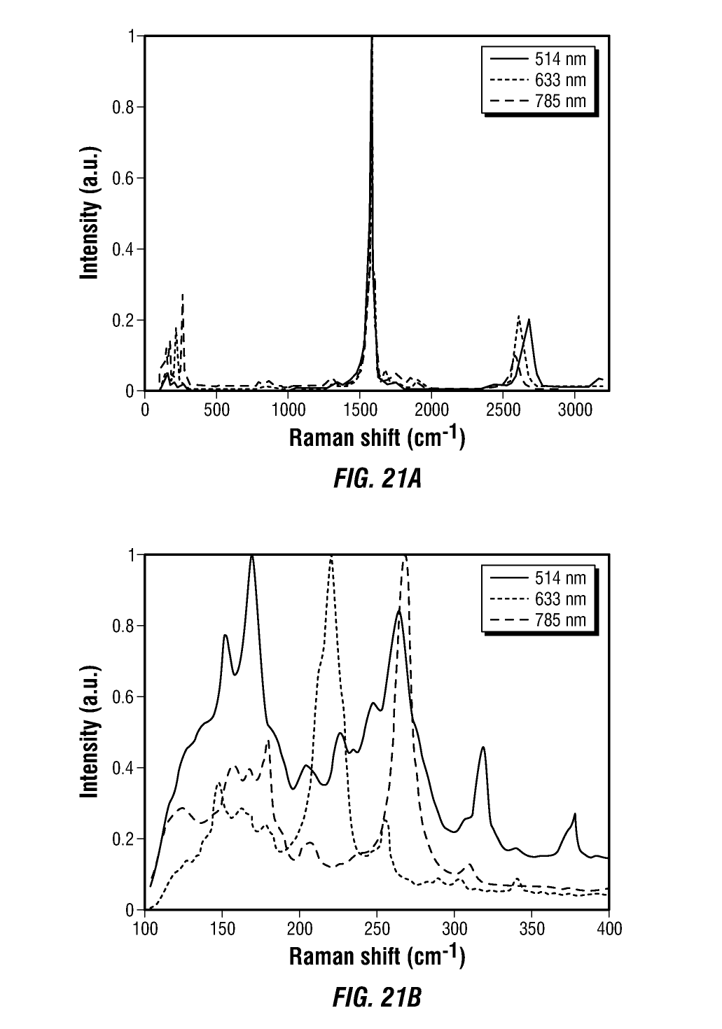

In order to show the inherent trade-off between conductivity and weight (FIG. 19A), Applicants measured the DC conductivity EM shielding normalized by its density (specific conductivity) and plotted it versus the EM shielding linear density (density per unit length). The CNT coating specific conductivity is comparable to that of tin and copper, but at least 30 times lighter than conventional metal braids. Specifically, the CNT EM shielding conductivity is about 650 kS/m (FIG. 20), roughly two orders of magnitude higher than previously reported CNT EM shielding. The high conductivity can be attributed to the high CNT quality (Raman of the CNT material before CSA dissolution showed a G/D ratio of ˜40, FIG. 21) and to acid doping that occurred during the coating process.

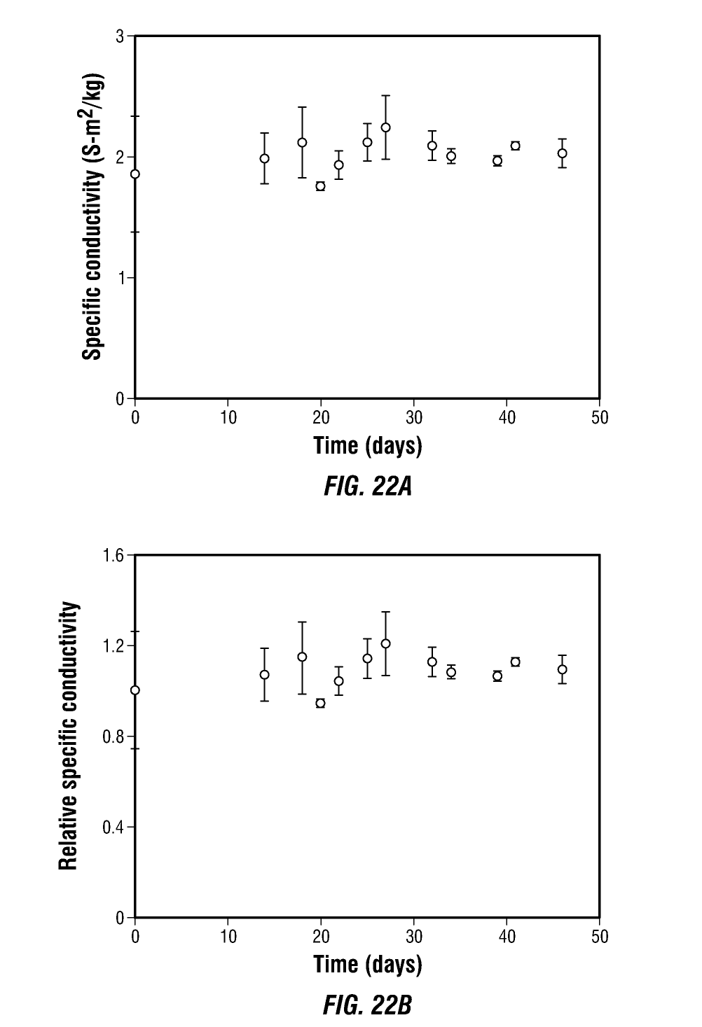

Despite the doping, the CNT electrical properties are stable over time (CNT coating specific conductivity versus time, FIG. 22) most likely due to acid entrapped inside the CNTs.

Applicants measured the alternating current (AC) electrical properties of the CNT and commercial cables over a frequency range of 50 MHz to 3 GHz with a broadband, multiline-thru-reflect technique using an open-short-load-through (OSLT) corrected vector network analyzer. To perform the multiline technique, Applicants fabricated six cables for each CNT coating thickness and for the commercial cables. The nominal lengths of the cables—(5.7, 7.4, 14.2, 22.2, 30.8, 36.9) cm—were chosen to optimally extract the propagation constant γ as a function of frequency. γ is a complex, frequency-dependent parameter (γ=α+iβ) that describes how an AC signal (or data) changes as a function of position along a coaxial cable and varies with time. The real part of the propagation constant is the attenuation (or loss) per unit length α as a function of frequency (FIG. 19B), and β is the phase constant. Lower the value of α, smaller the loss through the transmission line, leading to higher cable quality.

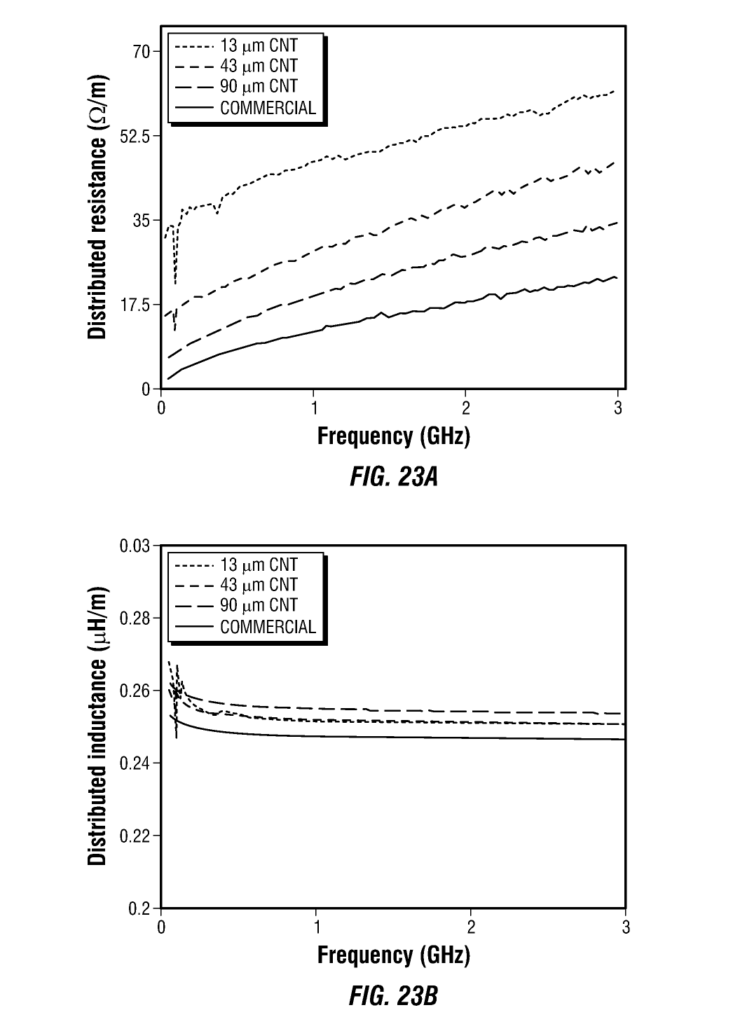

Applicants first measured the OSLT corrected complex scattering (S-) parameters of each cable, and then used the multiline algorithm to extract the propagation constant. Because of its basis in circuit theory, the multiline technique is considered the most accurate method to obtain γ. This was tested by a least-squares algorithm to fit OSLT corrected S-parameters to a distributed network model, which uses the length of the cable as the only input parameter (thinner line in FIG. 19B). This enabled the confirmation that exchanging the commercial metal mesh for the CNT layer only influenced the distributed resistance per unit length (cable distributed resistance versus frequency, FIG. 23). As expected, increasing the thickness of the CNT layer decreased the attenuation constant (FIG. 19B) in agreement with prior studies, and improved the CNT cable quality to a value that is comparable to that of the commercial cables.

Applicants present the aforementioned findings in terms of normalized attenuation at 1 GHz (a reference frequency for military specifications) and a parameterized mass. Applicants normalize the attenuation a by the military standard attenuation reported by MIL-C-17 (α₀) at 1 GHz for this cable type (dashed line in FIG. 19C) and the mass of the CNT EM shielding (m) by the corresponding mass of the commercial cable (m₀). When plotting α/α₀ versus m/m₀ (FIG. 19C), values closer to the origin have improved data transmission characteristics and lower weight. Compared to published results (squares in FIG. 19C), Applicants improved the attenuation two-fold without compromising mass, producing the best attenuation values to date for CNT cables.

In sum, Applicants have shown in the Example that coaxial cable outer conductors can be solution coated directly onto the dielectric to manufacture CNT coaxial data cables that meet military attenuation specifications at 1 GHz and have durability comparable to commercial cables. To Applicants' knowledge, these cables show the best values of attenuation to date and have an EM shielding mass 97% lighter than conventional metal braids with an overall cable weight reduction of ˜50%.

### Example 2.5. Carbon Nanotube Coating and Characterization

CNTs were purchased from Unidym and dispersed as received at the concentration of 1.3% by mass in CSA (Sigma Aldrich) using a speed mixer (DAC 150.1 FV-K, Flack Tek Inc). After coating the dielectric with the CNT solution at 100 mm/s (FIG. 9C), the coated dielectric was coagulated in ether for 1 hour, followed by an isopropanol wash for 30 min, then a water bath for 1 hour. The coated dielectric was then air dried at room conditions overnight. Once the coating was dried, Applicants estimated the mass of the CNT coating by first cutting a segment of coated dielectric. Applicants then melted the PE dielectric in a bath of dichlorobenzene heated at 150° C. for 20 minutes, followed by a 20 minute bath in dichloromethane at ambient conditions to remove the dichlorobenzene. The CNT coating was dried in the oven at 100° C. for 10 minutes and measured by a Citizen microbalance. Applicants determined the thickness of the coating by SEM imaging and a microcaliper (FIG. 10). Applicants verified CNT material quality by Raman Spectroscopy (FIG. 21).

### Example 2.6. Morphology Characterization

SEM images of the coating on the dielectric were taken by a microscope (FEI Quanta 400ESEM FEG). AFM measurements (Cypher AFM, Asylum/Oxford Instruments) were performed in tapping mode at ambient conditions. Applicants used a silicon cantilever (AC160TS-R3, Olympus) with a spring constant of approximately 30 N/m, a resonant frequency of 295 kHz, a free oscillation amplitude of 100 nm and an imaging set point ratio of approximately 85%. The linear tip speed during scanning was about 25 μm/s. Small-angle neutron scattering (SANS) measurements were performed at the 30 m NG7 SANS beam line at the NIST Center for Neutron Research (NCNR). The measurements were done using the standard SANS configurations, covering a Q-range of 0.003 Å⁻¹-0.55 Å⁻¹. Data reduction was performed using NCNR Igor macros and data fitting using the SasView software (www.sasview.org). The SANS measurements were performed on a piece of the CNT coating that was removed from the dielectric and sandwiched between two glass slides.

### Example 2.7. Mechanical Durability Testing

Fatigue testing was conducted using a 3-point bend test fixture attached to an MTS servohydraulic load frame (Model 312, 100 KN) equipped with a 15 KN actuator. The upper grip fixture held the 220 N compression/tension load cell with the anvil attached to push down on the cable. The support and loading anvils were equipped with 10 mm diameter bearings. The span between support anvils was 60 mm. A schematic of the experimental loading configuration is provided in FIG. 16. The cable was kept in tension across the support anvils by steel springs with spring constants of (488±2) mN/mm that were attached to the rigid coax connections to isolate fragile coax fitting from stress. The coiled springs were anchored to aluminum supports rigidly fixed to the 3-point bend fixture. The pre-tension axial force on the cable was (0.7±0.02) N which gave an approximate axial stress of 35 kPa on the cable. The cable was fatigued by positioning the anvil in direct contact with the cable at zero normal load on the load cell. The loading anvil was stationary and the support anvils, connected to the actuator, were oscillated using a triangular ramp with amplitude of 16 mm deflection at a rate of 5 Hz for 10,000 cycles. This motion resulted in bending the length of cable through a (27±2) mm radius of curvature. The normal load at maximum displacement was (13±1) N and the axial force, based on spring displacement, was approximately 4.6 N. During the fatigue test, the DC resistance measurements were taken using a Keithley 1700 multimeter after letting the cable settle for a period of two minutes to allow for thermal dissipation.

### Example 2.8. Electrical DC and AC Characterization

The CNT coaxial cables were fabricated from RG174U coax (FIG. 9A) and subsequently attached to female SMA connectors (FIG. 10). Two-point DC resistances were measured with Keithley 2000 multimeter. The microwave electrical measurements were performed on a vector network analyzer Hewlett Packard 8720D that was corrected with open-short-load (OSLT) lumped-element calibration artifacts. The StatistiCAL software package (http://www.nist.gov/pml/electromagnetics/related-software.cfm) was used to perform the multiline thru-reflect-line analysis.

### Example 2.9. Assembly of the CNT Cables

The presence of silver epoxy does not affect the microwave properties of the cables: commercial cables were tested with and without silver epoxy and no change in attenuation was observed. Silver epoxy was used only to increase the robustness of the connectors and guarantee a good contact between the outer conductor and the connector. The technique shown in FIG. 10 was also used for the commercial cables.

### Example 2.10. Thickness Measurement of the CNT Layer by SEM and Microcaliper

The CNT layer was detached from the dielectric by dissolving the PE with dichlorobenzene. The CNT layer cross section was then imaged from the top in at least 5 different areas by SEM. The removal of the PE dielectric allows for better SEM resolution. The microcaliper measurement was performed on at least 5 cables. The microcaliper and SEM measurements agree within ˜3-20%.

### Example 2.11. Rheology Measurements

The viscosity versus shear rate of CNT-CSA solutions with mass fraction of 1 and 1.3% was measured by an RDA III strain-controlled rheometer with shallow cup geometry. The solution was loaded between the two plates in an inert condition to avoid the acid from reacting with the moisture in the atmosphere. A layer of ultra-low viscosity Fluorinert FC-72 (ACROS Organics) was placed on the top of the loaded shallow cup to isolate the acid from the environment. Additionally, a layer of low viscosity silicon oil was added on the top to limit the evaporation of FC-72 during the experiment.

FIG. 12 shows viscosity η versus shear rate \dot{γ}. As expected, due to the shear thinning nature of the CNT-CSA solution, the viscosity of the solution decreases with shear rate following the power law relation η=K\dot{γ}ⁿ⁻¹, where K is the consistency index and n is the power law exponent.

Next, Applicants investigated if the coating thickness h_{dry} is related to the withdrawal speed u by the power law relation as previously reported for dip coating processes:

$${h}_{dry} = φ {h}_{wet} ∼ {u}^{\frac{2 n}{( 2 n + 1 )}} \qquad ( 1 )$$

In the above equation, φ is the volume fraction of CNTs in CSA and h_{wet} is the thickness of the coating on the dielectric before coagulation and drying. Specifically, the coatings were fabricated by varying the withdrawal speed for each concentration (1.3 and 1%) and the coating thickness was determined by observing the samples by SEM. The (2n/(2n+1)) exponent values obtained from lubrication analysis and rheology agree within 15% for the 1% solution and 3% for the 1.3% solution.

### Example 2.12. Polarized Raman Spectroscopy

Polarized resonance Raman spectroscopy was performed with a Renishaw in Via microscope on (90±14) μm sample to evaluate the macroscopic order parameter S. A 633 nm laser was scanned over 4.5 mm×0.6 mm to obtain 76 spectra (250 μm×200 μm step size) for 3 different scattering geometries and the intensities of the G⁺ peaks were used to calculate S. Assuming three dimensional order of the CNTs in the coating, S is given by:

$$S = \frac{3 {I}_{VV} + 3 {I}_{VH} - 4 {I}_{HH}}{3 {I}_{VV} + 12 {I}_{VH} + 8 {I}_{HH}} \qquad ( 2 )$$

In the above equation, subscripts denote laser polarity (incident polarization) and analyzer position (scattering polarization) with respect to CNT alignment. Specifically, VV represents laser polarity and analyzer position parallel to the cable axis, VH represents laser polarity parallel to the cable axis but perpendicular to the analyzer, and HH represents laser polarity and analyzer both perpendicular to the cable axis. I_{VH} and I_{HH} were obtained with the use of half-wave plates so that all 3 spectra were taken in the same positions along the coating. The laser was automatically focused before the acquisition of each spectrum by the WiRE software. The average order parameter obtained by Raman spectroscopy of 0.34±0.143 is in good agreement with the alignment factor from SANS (0.323, see following discussion), which has been shown to be equivalent to the order parameter for uniaxially aligned rigid rods.

### Example 2.13. Small-Angle Neutron Scattering on the CNT Coatings

Small-angle neutron scattering (SANS) measurements were taken on the CNT coatings with 90 μm and 43 μm thickness. Both samples show the same scattering behavior within a scaling factor. One of the data sets on the 43 μm thick coating is shown in FIG. 13C and FIG. 15. The anisotropy in the signal indicates orientational order along the cable axis and is only observable for length scales higher than 10 nm, which is attributed to CNT bundles rather than individual CNTs. The SANS signal was fitted to a 2D model of aligned fibers, yielding an average fiber diameter of approximately 45 nm (FIG. 15A). The degree of fiber alignment was quantified from annular averages of the 2D scattering profile over a narrow q-range close to the lowest accessed Q-values in order to capture the largest possible dimension of the aligned objects. For the 2D pattern shown in FIG. 15A, the annulus was chosen for Q values between 0.0045 Å⁻¹ and 0.0054 Å⁻¹, resulting in the intensity spectrum shown in FIG. 15B. The alignment angle and the angular distribution are obtained from fits to a Gaussian distribution of the hump-like structures (FIG. 15B) and were found to be 98° (mod π) and 20.4° (standard deviation), respectively. It is worth noting that in this case the alignment angle is determined by the orientation of the cable axis relative to the horizontal axis on the detector. The degree of alignment of the CNT bundles was obtained from fits of the 1D annularly-averaged data (FIG. 15B) to the Maier-Saupe distribution of the form:

$$F ( Q , ϕ ) = {\sum }_{n = 0}^{∞} {a}_{n} {P}_{2 n} ( cos ϕ ) \qquad ( 3 )$$

In the above equation, φ is the alignment angle obtained from the Gaussian fits, P₂ₙ are even Legendre polynomials and aₙ's are the fit parameters. Applicants truncated the series to the first five terms of the expansion, which sufficiently reproduced the measured signal. The alignment factor, A_{f}, is obtained from the fit parameter a₁ as A_{f}=a₁/5, and is ≈0.323 for the current sample. In general, A_{f} takes values between zero for randomly oriented fibers and 1 in the case of perfect alignment.

Insight about the intra-bundle configuration was obtained from the high-Q behavior of the circularly averaged SANS signal. A preliminary analysis of the 1D SANS data (FIG. 15C) using Power law shows that the scattering intensity at high Q deviates from Q⁻¹ dependence, associated with individual CNTs, and rather exhibits a Q^{-2.8} dependence, which is indicative of dense fractal networks. Indeed, the fit of the 1D data to a fractal model using the dimensions of the individual CNT (diameter˜1.2 nm), yielded a fractal dimension of 2.78 (FIG. 15C), consistent with the idea that the aligned bundles are formed of dense networks of individual CNTs.

### Example 2.14. CNT Liquid Crystalline Phase by Polarized Optical Microscopy

The solution of CNTs in CSA was characterized before coating the cables using a polarized optical microscope. A small drop of the 1.3 wt % solution was deposited on a glass slide, then a cover slip was placed on the top of the drop and sealed with tape to minimize the exposure to air. The sample was prepared in a glove box with humidity controlled environment (<10% humidity). The sample was observed by a Zeiss Axioplan optical microscope at 0 and 45 degrees with respect to the cross polars (analyzer and polarizer). The bright areas show the presence of a liquid crystalline phase, while the dark regions correspond to isotropic phase or areas where the CNTs are aligned in directions different than ±45° with respect to the cross polars.

### Example 2.15. DC Resistance of Inner and Outer Conductors Versus Cable Length

In FIG. 20, the DC resistance of inner and outer conductor is plotted versus cable length showing a linear dependence of the DC resistance with cable length. The conductivity σ_{DC} of the CNT outer conductor was found to be (0.65±0.01) MS/m and was calculated from the slopes of the DC resistance R_{DC} versus length/in FIG. S8b (A is the cross sectional area):

$${σ}_{DC} = \frac{l}{{R}_{DC} A} = \frac{1}{slope A} \qquad ( 4 )$$

The specific conductivity reported in FIG. 19A was obtained by normalizing the conductivity by the CNT film density, (440±105) kg/m³. As expected, the specific conductivity is constant independently of the CNT coating thickness, approximately 1,500 Sm²/kg. The specific conductivity of the metal mesh (tinned copper) is lower than the specific conductivity of bare copper (2.7 kSm²/kg versus 6.6 kSm²/kg), which is most likely due to the presence of tin.

### Example 2.16. CNT Powder Characterization by Raman Spectroscopy

Raman spectroscopy was performed directly on the CNT powder using a Renishaw inViaRamanMicroscope* with 514, 633, and 785 nm wavelength lasers. The objective was 50× and the acquisition time was 10 s. The CNT powder was characterized by Raman spectroscopy before acid dissolution. As shown in FIG. 21A, the G/D ratio is ˜40, confirming the high CNT quality. The radial breathing mode (RBM) (FIG. 21B) shows several peaks due to the presence of CNTs with different diameters.

### Example 2.17. Specific Conductivity and Relative Specific Conductivity

The specific conductivity reported in FIG. 22 was measured by a 4 point probe directly on the CNT coating by connecting the CNT coating with alligator clips at the ends and using inner probes to test the coating resistance in between connections. Four-point probe measurements were taken with a Hewlett Packard 34401A multimeter. The specific conductivity obtained using this technique is (2.0±0.3) kSm²/kg, which is consistent with the values shown in FIG. 20. FIG. 22B shows the relative specific conductivity (specific conductivity normalized by the initial specific conductivity at day 1) versus time measured by 4 point probe method. The relative specific conductivity was constant for more than 40 days confirming that the electrical conductivity of the CNT coatings is stable in time.

### Example 2.18. Multiline Thru-Reflect-Line (TRL) Calibration and Equivalent Circuit Parameters

An open-short-load-thru (OSLT) first tier calibration was carried out using lumped element calibration standards. Applicants then extracted the propagation constants of standard and CNT cables following the multiline TRL technique.

FIG. 23 shows the distributed resistance and inductance per unit cable length as a function of frequency. After Applicants extracted the propagation constant from multiline TRL, Applicants assumed that the distributed capacitance (C=101 pF/cm) and conductance (G=0) per unit length were constant as function of frequency, which was verified by the fitting technique. As expected, the distributed resistance decreases with CNT shield thickness since DC resistance decreases with outer conductor thickness. The distributed resistance increases with frequency due to skin effect and exhibits similar frequency dependence comparable to the attenuation because α˜R up to an additive constant. The skin depth δ in the shielding layer was measured to be ˜20 μm at 1 GHz, assuming the relative permeability of CNTs μᵣ=1. Since 98% of the current flows on a thickness corresponding to 4δ and no improvement in attenuation is found when the coating exceeds 4δ in thickness, the maximum CNT thickness produced was 90 μm at which the best attenuation is reached. The skin effect also causes the distributed inductance to decrease with frequency, reaching a constant value corresponding to the geometrical inductance. The inductance value obtained for the thickest CNT cable was 25.3 μH/m which is consistent with the value of 25.26 μH/m in the cable specification sheet.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making a carbon nanotube-coated substrate, said method comprising:
dissolving carbon nanotubes in a solvent to form a carbon nanotube solution; and
coating a surface of the substrate with the carbon nanotube solution,
wherein the coating forms one or more carbon nanotube layers on the surface of the substrate.

2. The method of claim 1, wherein the dissolving occurs by mixing the carbon nanotubes with the solvent.

3. The method of claim 1, wherein the solvent comprises a strong acid.

4. The method of claim 1, wherein the solvent comprises a superacid.

5. The method of claim 4, wherein the superacid is selected from the group consisting of Bronsted superacids, Lewis superacids, conjugate Bronsted-Lewis superacids, and combinations thereof.

6. The method of claim 1, wherein the solvent comprises a strong acid or a superacid selected from the group consisting of perchloric acid, chlorosulfonic acid, fluorosulfonic acid, trifluoromethane sulfonic acid, perfluoroalkane sulfonic acids, antimony pentafluoride, arsenic pentafluoride, oleums, polyphosphoric acid-oleum mixtures, tetra(hydrogen sulfate)boric acid-sulfuric acid, fluorosulfuric acid-antimony pentafluoride, fluorosulfuric acid-SO₃, fluorosulfuric acid-arsenic pentafluoride, fluorosulfonic acid, fluorosulfonic acid-hydrogen fluoride-antimony pentafluoride, fluorosulfonic acid-antimony pentafluoride-sulfur trioxide, fluoroantimonic acid, tetrafluoroboric acid, triflic acid, and combinations thereof.

7. The method of claim 1, wherein the carbon nanotubes are selected from the group consisting of metallic carbon nanotubes, semiconducting carbon nanotubes, single-walled carbon nanotubes, multi-walled carbon nanotubes, few-walled carbon nanotubes, double-walled carbon nanotubes, triple-walled carbon nanotubes, ultra-short carbon nanotubes, and combinations thereof.

8. The method of claim 1, wherein the carbon nanotube solution is in a liquid crystalline state.

9. The method of claim 1, wherein the carbon nanotube solution is in an isotropic phase.

10. The method of claim 1, wherein the carbon nanotube solution is in a liquid crystalline state and an isotropic phase.

11. The method of claim 1, wherein the carbon nanotube solution has a carbon nanotube concentration ranging from about 0.01% by weight to about 20% by weight.

12. The method of claim 1, wherein the coating occurs by a method selected from the group consisting of dip coating, wire coating, die coating, slot coating, extrusion coating, slide coating, knife coating, blade coating, roll coating, and combinations thereof.

13. The method of claim 1, wherein the coating occurs by dip coating.

14. The method of claim 1, wherein the carbon nanotube-coated substrate is a component of a cable, and wherein the cable comprises:
one or more internal conductors; and
one or more internal insulating layers surrounding a surface of the one or more internal conductors,
wherein the carbon nanotube solution is coated onto a surface of the one or more internal insulating layers to form one or more carbon nanotube layers on the surface of the one or more internal insulating layers.

15. The method of claim 14, wherein the one or more internal conductors are selected from the group consisting of metals, carbon nanotubes, graphenes, carbons, and combinations thereof.

16. The method of claim 14, wherein the one or more internal conductors comprises carbon nanotube fibers.

17. The method of claim 14, wherein the one or more carbon nanotube layers are in direct contact with the one or more internal insulating layers.

18. The method of claim 18, wherein the substrate is in the form of a sheet comprising a front surface and a back surface, and wherein the carbon nanotube solution is coated onto at least one of the front surface and the back surface of the substrate to form one or more carbon nanotube layers on at least one of the front surface and the back surface of the substrate.

19. The method of claim 18, wherein the carbon nanotube solution is coated onto the front surface and the back surface of the substrate to form one or more carbon nanotube layers on each of the front surface and the back surface of the substrate.

20. The method of claim 1, further comprising a step of associating the carbon nanotube-coated substrate with one or more external insulating layers.

21. The method of claim 1, wherein the one or more carbon nanotube layers comprise unidirectionally aligned carbon nanotubes.

22. The method of claim 21, wherein the unidirectionally aligned carbon nanotubes are aligned along an axis of the substrate.

23. The method of claim 21, wherein the unidirectionally aligned carbon nanotubes are in the form of bundles.

24. The method of claim 1, wherein the one or more carbon nanotube layers comprise neat carbon nanotubes.

25. The method of claim 1, wherein the one or more carbon nanotube layers have a thickness ranging from about 1 μm to about 500 μm.

26. The method of claim 1, wherein the one or more carbon nanotube layers have a carbon nanotube content ranging from about 50% by weight to about 90% by weight.

27. The method of claim 1, wherein the one or more carbon nanotube layers surround an entire outer surface of the substrate.

28. The method of claim 1, further comprising a step of removing the solvent from the carbon nanotubes.

29. The method of claim 28, wherein the removing occurs by coagulation.

30. The method of claim 29, wherein the coagulation occurs by exposure of the carbon nanotubes to a coagulant.

31. The method of claim 30, wherein the coagulant is selected from the group consisting of water, hexane, ether, isopropanol, diethyl ether, poly(ethylene glycol), dimethyl sulfoxide (DMSO), poly(vinyl alcohol), sulfuric acid, dichloromethane, trichloromethane, chloroform, acetone, tetrachloroethane, sulfolane, Triton-X, polymerizable monomers, N-methyl pyrrolidone (NMP), alcohols, methanol, ethanol, propanol, and combinations thereof.

32. The method of claim 1, further comprising a step of washing the carbon nanotubes.

33. The method of claim 1, further comprising a step of drying the carbon nanotubes.

34. The method of claim 1, wherein the method occurs without mechanical weaving or mechanical rolling.

35. The method of claim 1, wherein the one or more carbon nanotube layers have an electrical conductivity ranging from about 100 kS/m to about 700 kS/m.

36. The method of claim 1, wherein the one or more carbon nanotube layers have a specific electrical conductivity ranging from about 1,000 Sm²/Kg to about 2,500 Sm²/Kg.

37. The method of claim 1, wherein the one or more carbon nanotube layers have a weight ranging from about 0.01 g/m to about 0.5 g/m.

38. The method of claim 1, wherein the carbon nanotube-coated substrate is a component of a cable, wherein the cable has attenuation values of less than about 3 dB/m or less than about 90 dB/100 ft at 1 GHz.

39. The method of claim 1, wherein the one or more carbon nanotube layers serve as an outer conductor of a cable, and wherein the direct current electric resistance of the one or more carbon nanotube layers does not substantially increase with repeated bending.

40. The method of claim 1, wherein the carbon nanotube-coated substrate is a component of a cable, and wherein the insertion loss of the cable does not substantially increase with repeated bending.

41. A substrate comprising:
one or more carbon nanotube layers,
wherein the one or more carbon nanotube layers are derived from a carbon nanotube solution.

42. The substrate of claim 41, wherein the carbon nanotube solution is in a liquid crystalline state.

43. The substrate of claim 41, wherein the carbon nanotube solution is in an isotropic phase.

44. The substrate of claim 41, wherein the carbon nanotube solution is in a liquid crystalline state and an isotropic phase.

45. The substrate of claim 41, wherein the carbon nanotube solution has a carbon nanotube concentration ranging from about 0.01% by weight to about 20% by weight.

46. The substrate of claim 41, wherein the one or more carbon nanotube layers comprise unidirectionally aligned carbon nanotubes.

47. The substrate of claim 46, wherein the unidirectionally aligned carbon nanotubes are aligned along an axis of the substrate.

48. The substrate of claim 46, wherein the unidirectionally aligned carbon nanotubes are in the form of bundles.

49. The substrate of claim 41, wherein the one or more carbon nanotube layers comprise neat carbon nanotubes.

50. The substrate of claim 41, wherein the one or more carbon nanotube layers have a thickness ranging from about 1 μm to about 500 μm.

51. The substrate of claim 41, wherein the one or more carbon nanotube layers have a carbon nanotube content ranging from about 50% by weight to about 90% by weight.

52. The substrate of claim 41, wherein the one or more carbon nanotube layers surround an entire outer surface of the substrate.

53. The substrate of claim 41, wherein the one or more carbon nanotube layers comprise carbon nanotubes selected from the group consisting of metallic carbon nanotubes, semiconducting carbon nanotubes, single-walled carbon nanotubes, multi-walled carbon nanotubes, few-walled carbon nanotubes, double-walled carbon nanotubes, triple-walled carbon nanotubes, ultra-short carbon nanotubes, and combinations thereof.

54. The substrate of claim 41, wherein the substrate is a component of a cable, and wherein the cable comprises:
one or more internal conductors; and
one or more internal insulating layers surrounding a surface of the one or more internal conductors, wherein the one or more carbon nanotube layers are on a surface of the one or more internal insulating layers.

55. The substrate of claim 54, wherein the one or more internal conductors are selected from the group consisting of metals, carbon nanotubes, graphenes, carbons, and combinations thereof.

56. The substrate of claim 54, wherein the one or more internal conductors comprises carbon nanotube fibers.

57. The substrate of claim 54, wherein the one or more carbon nanotube layers are in direct contact with the one or more internal insulating layers.

58. The substrate of claim 41, wherein the substrate is in the form of a sheet comprising a front surface and a back surface, and wherein the carbon nanotube layers are on at least one of the front surface and the back surface of the substrate.

59. The substrate of claim 58, wherein the one or more carbon nanotube layers are on each of the front surface and the back surface of the substrate.

60. The substrate of claim 41, further comprising one or more external insulating layers.

61. The substrate of claim 41, wherein the one or more carbon nanotube layers have an electrical conductivity ranging from about 100 kS/m to about 700 kS/m.

62. The substrate of claim 41, wherein the one or more carbon nanotube layers have a specific electrical conductivity ranging from about 1,000 Sm²/Kg to about 2,500 Sm²/Kg.

63. The substrate of claim 41, wherein the one or more carbon nanotube layers have a weight ranging from about 0.01 g/m to about 0.5 g/m.

64. The substrate of claim 41, wherein the substrate is a component of a cable, and wherein the cable has attenuation values of less than about 3 dB/m or less than about 90 dB/100 ft at 1 GHz.

65. The substrate of claim 41, wherein the one or more carbon nanotube layers serve as an outer conductor of a cable, and wherein the direct current electric resistance of the one or more carbon nanotube layers does not substantially increase with repeated bending.

66. The substrate of claim 41, wherein the substrate is a component of a cable, and wherein the insertion loss of the cable does not substantially increase with repeated bending.
